(19) United States
(12) Patent Application Publication
(10) Pub. No.: US 2023/0146833 A1
(43) Pub. Date: May 11, 2023

(54) CELL-LEVEL SRS CONFIGURATION FOR CROSS-LINK INTERFERENCE MANAGEMENT IN FULL DUPLEX

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Huilin XU, Temecula, CA (US); Seyedkianoush HOSSEINI, San Diego, CA (US); Ahmed Attia ABOTABL, San Diego, CA (US)

(21) Appl. No.: 17/454,606

(22) Filed: Nov. 11, 2021

(51) Int. Cl. H04W 24/10; H04L 5/00; H04W 24/08

(52) U.S. Cl. CPC H04W 24/10; H04L 5/0048; H04W 24/08

(57) ABSTRACT

The apparatus may be configured to transmit a configuration of a first set of common resources for a SRS for cross-link interference measurement, the first set of common resources being common to a first plurality of UEs. The apparatus may further be configured to receive, from a second UE in the first plurality of UEs, a report of the cross-link interference associated with a first UE in the first plurality of UEs and measured via a first resource in the first set of common resources. In some aspects, another apparatus may be configured to receive, from a base station, a configuration indicating a set of common resources for a SRS for cross-link interference measurement between UEs. The apparatus may further be configured to transmit a first SRS in a first resource in the set of common resources.

### TECHNICAL FIELD

The present disclosure relates generally to communication systems, and more particularly, to intra-cell cross-link interference (CLI).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first device at a base station or a base station itself. The apparatus may be configured to transmit a configuration of a first set of common resources for a SRS for cross-link interference measurement, the first set of common resources being common to a first plurality of UEs. The apparatus may further be configured to receive, from a second UE in the first plurality of UEs, a report of the cross-link interference associated with a first UE in the first plurality of UEs and measured via a first resource in the first set of common resources.

In an aspect of the disclosure, a method, a computer-readable medium, and an apparatus are provided. The apparatus may be a second device at a UE or a UE itself. The apparatus may be configured to receive, from a base station, a configuration indicating a set of common resources for a SRS for cross-link interference measurement between UEs. The apparatus may further be configured to transmit a first SRS in a first resource in the set of common resources.

In an aspect of the disclosure, a method, a computer-readable medium, and an apparatus are provided. The apparatus may be a third device at a UE or a UE itself. The apparatus may be configured to receive, from a base station, a configuration indicating a first set of common resources for a SRS for cross-link interference measurement between UEs. The apparatus may further be configured to measure a cross-link interference from a SRS transmission received from a first UE via a first resource in the first set of common resources. The apparatus may further be configured to transmit, to the base station, a report of the measured cross-link interference.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network, in accordance with various aspects of the present disclosure.

FIG. 4A shows a first example of full-duplex communication in which a first base station is in full duplex communication with a first UE and a second UE, in accordance with various aspects of the present disclosure.

FIG. 4B shows a second example of full-duplex communication in which a first base station is in full-duplex communication with a first UE, in accordance with various aspects of the present disclosure.

FIG. 4C shows a third example of full-duplex communication in which a first UE is a full-duplex UE in communication with a first base station and a second base station, in accordance with various aspects of the present disclosure.

FIG. 5 illustrates example aspects of full-duplex resources, in accordance with various aspects of the present disclosure.

FIG. 6 illustrates an example communication system with a full-duplex base station that includes intra-cell CLI caused to a first UE by a second UE that are located within the same cell coverage as well as inter-cell interference from a base station outside of the cell coverage, in accordance with various aspects of the present disclosure.

FIG. 7 illustrates CLI and CLI leakage in SBFD and IBFD, in accordance with various aspects of the present disclosure.

FIG. 8 illustrates a set of SRS associated with (e.g., transmitted by) a set of UEs communicating with a base station, in accordance with various aspects of the present disclosure.

FIG. 9 is a call flow diagram illustrating a set of operations associated with CLI measurement based on a cell-level SRS configuration, in accordance with various aspects of the present disclosure.

FIG. 10 illustrates example sub-cell-level CLI-SRS configuration implementations, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a diagram illustrating an example of a hardware implementation for an apparatus, in accordance with various aspects of the present disclosure.

FIG. 17 is a diagram illustrating an example of a hardware implementation for an apparatus, in accordance with various aspects of the present disclosure.

FIG. 18 illustrates aspects of an example slot structure for sidelink communication, in accordance with various aspects of the present disclosure.

### DETAILED DESCRIPTION

For wireless communication with a base station, a UE may be configured to transmit a sounding reference signal (SRS) to the base station. The base station uses the SRS to perform uplink measurements for the UE. A UE may experience interference due to transmissions to and/or from another UE. The other UE may communicate with the same cell as the UE experiencing the interference, or may communicate with another cell. Aspects presented herein provide for CLI-SRS resources to be configured by a base station for each of a plurality of UEs served by the base station. A first UE may measure the CLI-SRS transmission of a second UE to determine cross-link interference experienced by the first UE due to uplink transmissions of the second UE. In order to measure CLI, CLI-SRS resources, aspects presented herein provide for alignment in the CLI-SRS resources for different user equipments (UEs) in the plurality of UEs. A base station may align a zero-power (ZP) CLI-SRS at a first UE with a non-ZP-CLI-SRS (e.g., a SRS transmission) at a second UE. Some aspects provide group-based (e.g., cell level, zone-based, or aggressor-based) CLI-SRS configurations that reduce management overhead associated with aligning CLI-SRS resources at different UEs independently. The group-based CLI-SRS resources may be used in association with communication between a UE and a base station or in association with sidelink communication.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

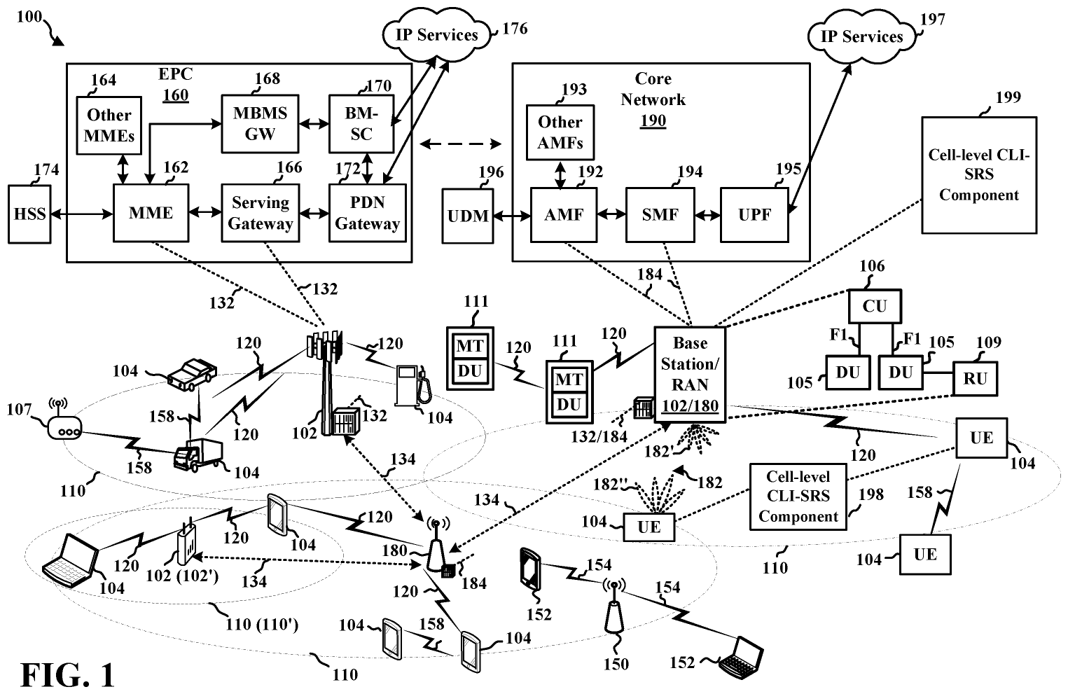

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 106, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs 105 may be connected via an F1 interface. A DU 105 and an RU 109 may be connected via a fronthaul interface. A connection between the CU 106 and a DU 105 may be referred to as a midhaul, and a connection between a DU 105 and an RU 109 may be referred to as a fronthaul. The connection between the CU 106 and the core network may be referred to as the backhaul. The RAN may be based on a functional split between various components of the RAN, e.g., between the CU 106, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 106 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 106 and a DU 105. IAB nodes 111 may include a DU 105 and a mobile termination (MT). The DU 105 of an IAB node 111 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNB s) (HeNB s), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

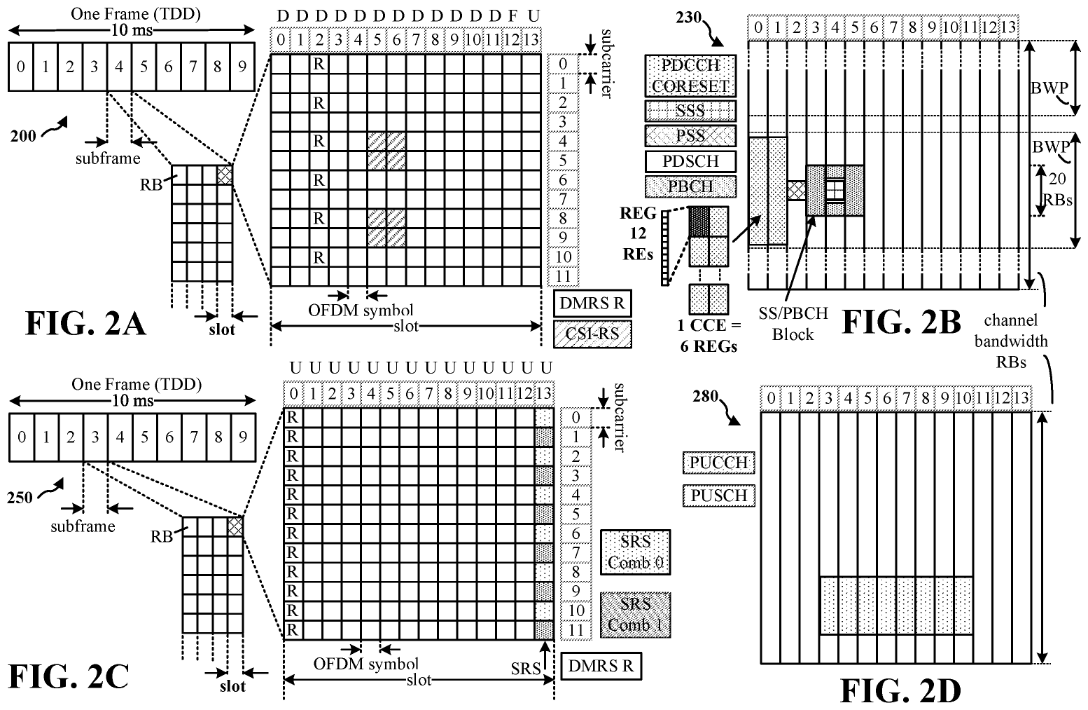

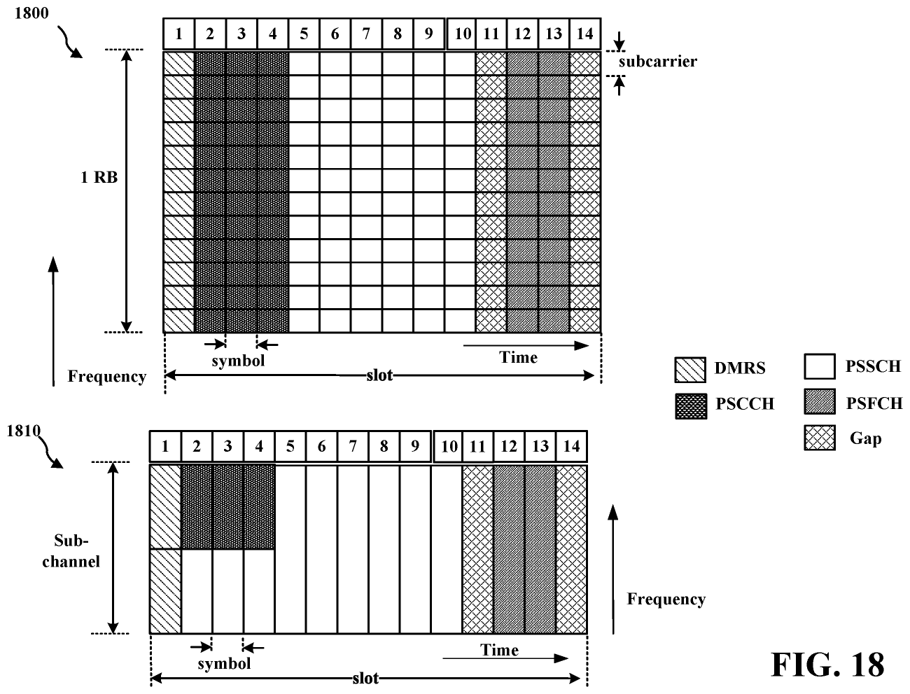

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 18. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a cell-level CLI-SRS component 198 configured to receive, from a base station, a configuration indicating a set of common resources for a SRS for cross-link interference measurement between UEs. The cell-level CLI-SRS component 198 may further be configured to transmit a first SRS in a first resource in the set of common resources. In some aspects, the cell-level CLI-SRS component 198 may be configured to receive, from a base station, a configuration of a first set of common resources for a SRS for cross-link interference measurement between UEs. The cell-level CLI-SRS component 198 may be configured to measure a cross-link interference from a SRS transmission received from a first UE via a first resource in the first set of common resources. The cell-level CLI-SRS component 198 may further be configured to transmit, to the base station, a report of the measured cross-link interference. The cell-level CLI-SRS component 198 may further be configured to transmit a second SRS via a second resource in the first set of common resources for measurement of the cross-link interference from the second UE. In certain aspects, the base station 180 may include a cell-level CLI-SRS component 199 configured to transmit a configuration of a first set of common resources for a SRS for cross-link interference measurement, the first set of common resources being common to a first plurality of UEs. The cell-level CLI-SRS component 199 may further be configured to receive, from a second UE in the first plurality of UEs, a report of the cross-link interference associated with a first UE in the first plurality of UEs and measured via a first resource in the first set of common resources. Although the following description may be focused on 5G NR, the concepts described herein may be applicable to other similar areas, such as LTE, LTE-A, CDMA, GSM, and other wireless technologies.

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

FIG. 18 includes diagrams 1800 and 1810 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 18 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 1800 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 1810 in FIG. 18 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 18, some of the REs may include control information in PSCCH and some REs may include demodulation RS (DMRS). At least one symbol may be used for feedback. FIG. 18 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 18. Multiple slots may be aggregated together in some aspects.

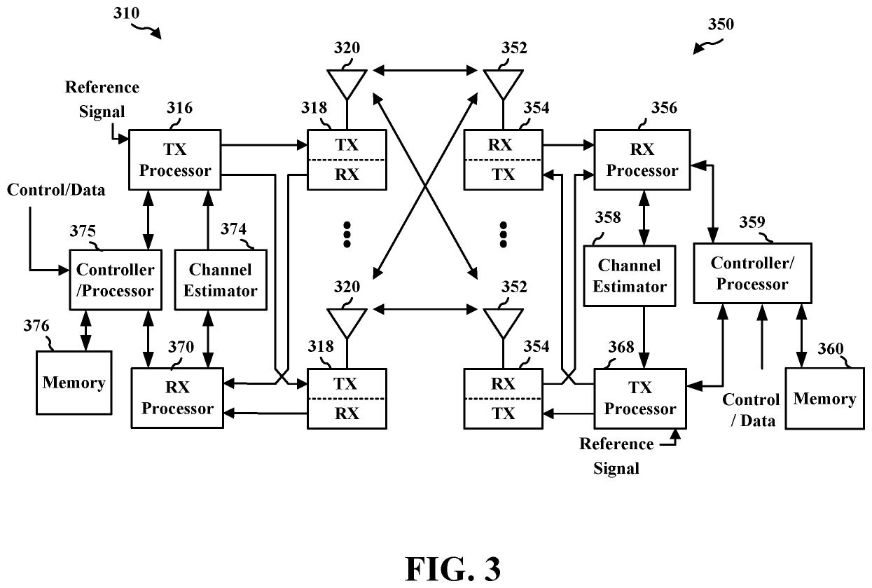

FIG. 3 is a block diagram of a first wireless device in communication with a second wireless device. Although aspects will be described in connection with a base station 310 in communication with a UE 350 in an access network, in some aspects, the first wireless device may be a UE that measures SRS transmissions from the second device, e.g., the second device may be a second UE. In some aspects, the first and the second UE may communicate with a base station based in an access network based on Uu communication. In some aspects, the first UE and the second UE may communicate based on sidelink. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The UL transmission is processed at the base station 310 in a manner similar to that described in connection with the receiver function at the UE 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

Wireless communication systems may be configured to share available system resources and provide various telecommunication services (e.g., telephony, video, data, messaging, broadcasts, etc.) based on multiple-access technologies that support communication with multiple users.

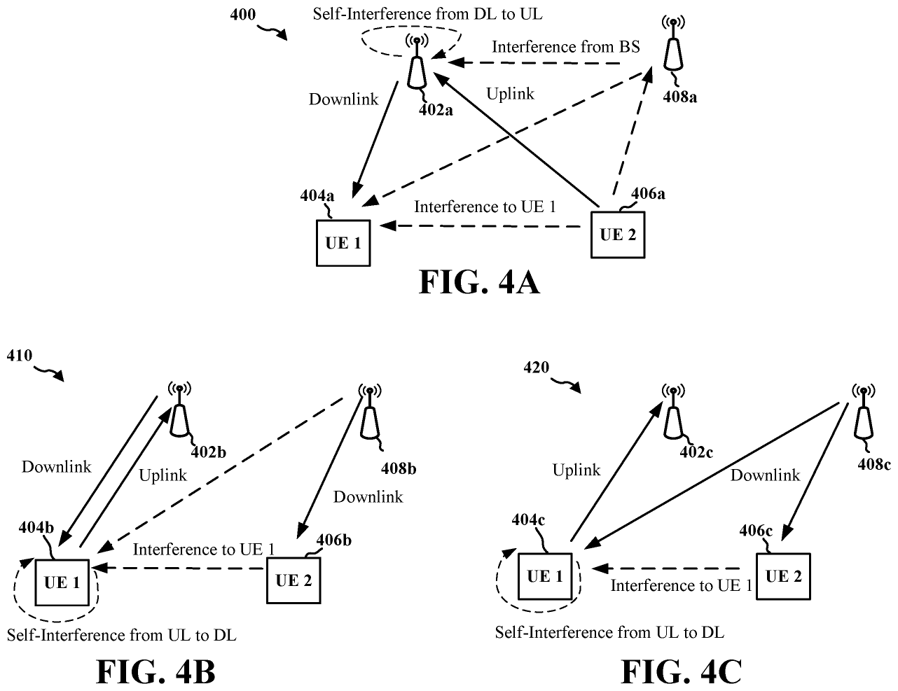

FIGS. 4A-4C illustrate various modes of full-duplex communication and interference that may be experienced by one or more devices. Full-duplex communication supports transmission and reception of information over a same frequency band in a manner that overlaps in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full-duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 4A shows a first example of full duplex communication 400 in which a first base station 402a is in full duplex communication with a first UE 404a and a second UE 406a. The first UE 404a and the second UE 406a may be configured for half-duplex communication or full-duplex communication. FIG. 4A illustrates the first UE 404a performing downlink reception, and the second UE 406a performing uplink transmission. The second UE 406a may transmit a first uplink signal to the first base station 402a as well as to other base stations, such as a second base station 408a in proximity to the second UE 406a. The first base station 402a transmits a downlink signal to the first UE 404a concurrently (e.g., overlapping at least partially in time) with receiving the uplink signal from the second UE 406a. The base station 402a may experience self-interference at its receiving antenna that is receiving the uplink signal from UE 406a, the self-interference being due to reception of at least part of the downlink signal transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows a second example of full-duplex communication 410 in which a first base station 402b is in full-duplex communication with a first UE 404b. In this example, the UE 404b is also operating in a full-duplex mode. The first base station 402b and the UE 404b receive and transmit communication that overlaps in time and is in a same frequency band. The base station and the UE may each experience self-interference, due to a transmitted signal from the device leaking to (e.g., being received by) a receiver at the same device. The first UE 404b may experience additional interference based on one or more signals emitted from a second UE 406b and/or a second base station 408b in proximity to the first UE 404b.

FIG. 4C shows a third example of full-duplex communication 420 in which a first UE 404c transmits and receives full-duplex communication with a first base station 402c and a second base station 408c. The first base station 402c and the second base station 408c may serve as multiple transmission and reception points (multi-TRPs) for UL and DL communication with the UE 404c. The second base station 408c may also exchange communication with a second UE 406c. In FIG. 4C, the first UE 404c may transmit an uplink signal to the first base station 402c that overlaps in time with receiving a downlink signal from the second base station 408c. The first UE 404c may experience self-interference as a result of receiving at least a portion of the first signal when receiving the second signal, e.g., the UE's uplink signal to the base station 402c may leak to (e.g., be received by) the UE's receiver when the UE is attempting to receive the signal from the other base station 408c. The first UE 404c may experience additional interference from the second UE 406c.

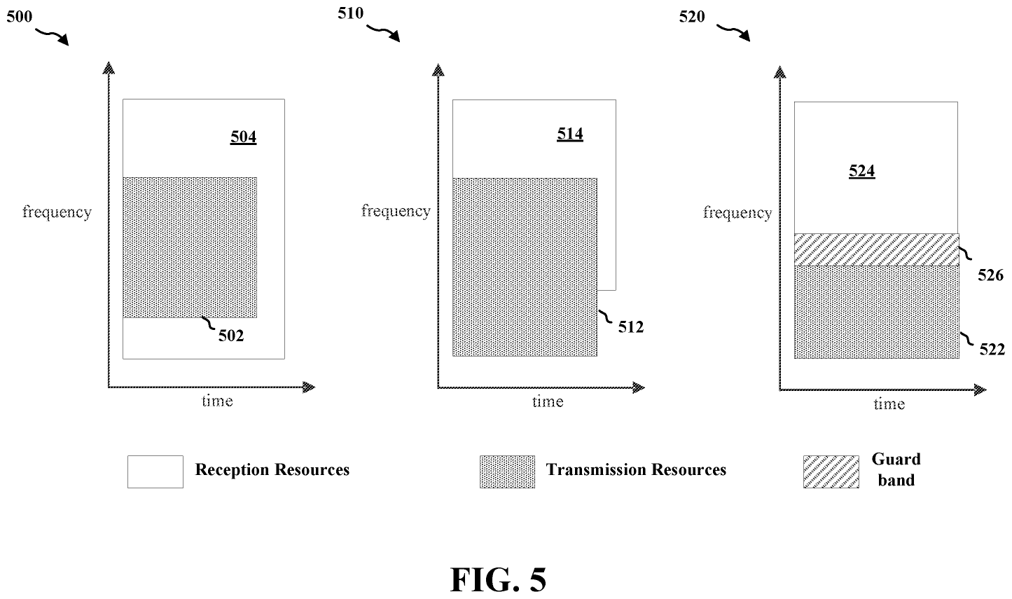

Full duplex communication may be in a same frequency band. The uplink and downlink communication may be in different frequency subbands, in the same frequency subband, or in partially overlapping frequency subbands. FIG. 5 illustrates a first example 500 and a second example 510 of in-band full-duplex (IBFD) resources and a third example 520 of sub-band full-duplex resources. In IBFD, signals may be transmitted and received in overlapping times and overlapping in frequency. As shown in the first example 500, a time and a frequency allocation of transmission resources 502 may fully overlap with a time and a frequency allocation of reception resources 504. In the second example 510, a time and a frequency allocation of transmission resources 512 may partially overlap with a time and a frequency of allocation of reception resources 514.

IBFD is in contrast to sub-band FDD, where transmission and reception resources may overlap in time using different frequencies, as shown in 520. As shown in 520, the transmission resources 522 are separated from the reception resources 524 by a guard band 526. The guard band may be frequency resources, or a gap in frequency resources, provided between the transmission resources 522 and the reception resources 524. Separating the transmission frequency resources and the reception frequency resources with a guard band may help to reduce self-interference. Transmission resources and a reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”.

If the full-duplex operation is for a UE or a device implementing UE functionality, the transmission resources 502, 512, and 522 may correspond to uplink resources, and the reception resources 504, 514, and 524 may correspond to downlink resources, in some aspects. Alternatively, if the full-duplex operation is for a base station or a device implementing base station functionality, the transmission resources 502, 512, and 522 may correspond to downlink resources, and the reception resources 504, 514, and 524 may correspond to uplink resources.

A slot format may be referred to as a “D+U” slot when the slot has a frequency band that is used for both uplink and downlink transmissions. The downlink and uplink transmissions may occur in overlapping frequency resources, such as shown in 504 and 506 (e.g., in-band full duplex resources) or may occur in adjacent or slightly separated frequency resources, such as shown in 520 (e.g., sub-band full duplex resources). In a particular D+U symbol, a half-duplex device may either transmit in the uplink band or receive in the downlink band. In a particular D+U symbol, a full-duplex device may transmit in the uplink band and receive in the downlink band, e.g., in the same symbol or in the same slot. A D+U slot may include downlink only symbols, uplink only symbols, and full-duplex symbols.

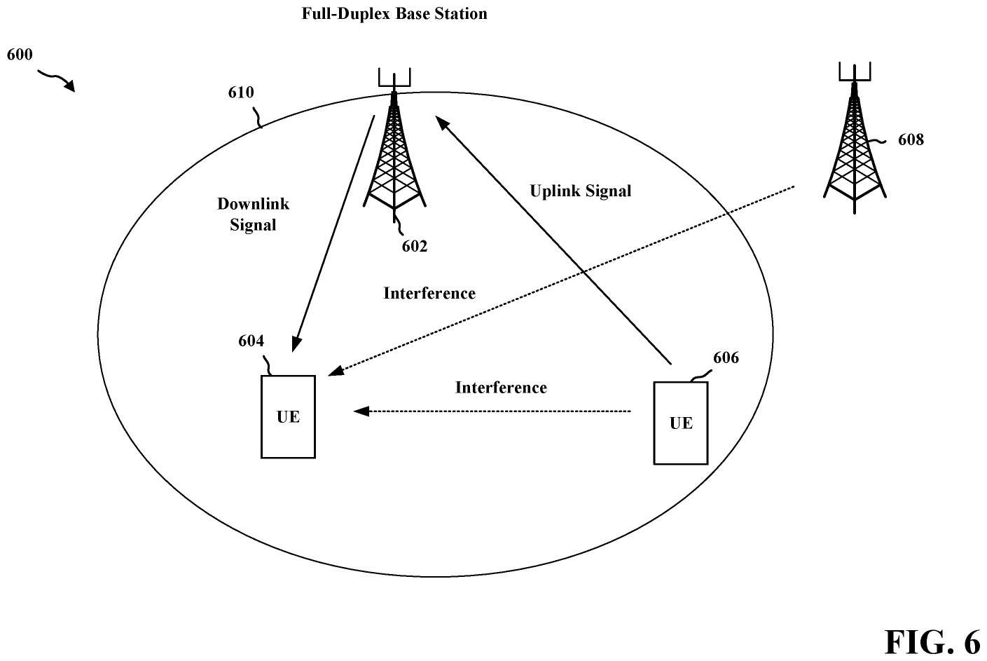

FIG. 6 illustrates an example communication system 600 with a full-duplex base station 602 that includes intra-cell cross-link interference (CLI) caused to UE 604 by UE 606 that are located within the same cell coverage 610 as well as inter-cell interference from a base station 608 outside of the cell coverage 610. The full-duplex base station may be operating in one of a sub-band full duplex (SBFD) mode or an IBFD mode. Although not shown, a full-duplex UE may cause self-interference to its own downlink reception. In SBFD, a base station may configure a downlink transmission to a UE in frequency domain resources that are adjacent to frequency domain resources for uplink transmissions for another UE. For example, in FIG. 6, the frequency resources for the downlink transmission to the UE 604 may be adjacent to the frequency resources for the uplink transmission from the UE 606.

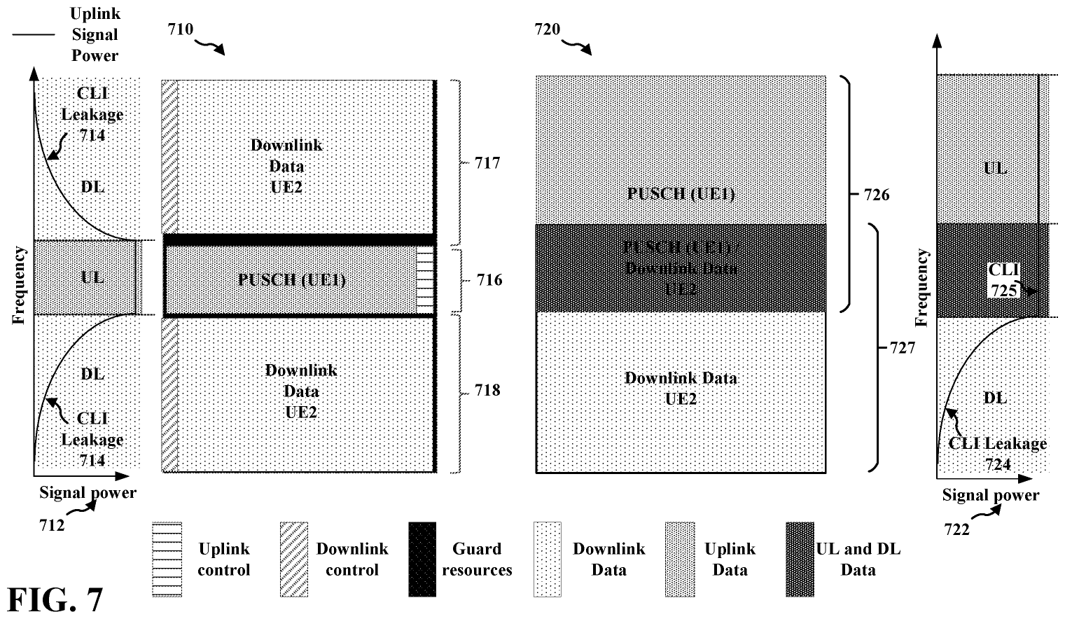

FIG. 7 illustrates aspects of CLI and CLI leakage in SBFD and IBFD. In some aspects, the CLI may be due to energy leakage caused by timing and frequency misalignment between uplink resources and downlink resources associated with different UEs (e.g., a UE 1 and a UE2, respectively), or due to automatic gain control (AGC) mismatch if the AGC for UE2 is driven by a DL serving cell signal associated with UE2, but the CLI 725 (or CLI leakage 714 or 724) is strong enough to saturate the AGC. In SBFD, a base station (e.g., the base station 602) may configure the DL transmission to a UE (e.g., ‘UE2’ or the UE 604) in frequency domain resources 717 and 718 adjacent to the frequency domain resources 716 configured for UL transmission from another UE (e.g., ‘UE1’ or the UE 606).

Diagram 710 illustrates a set of SBFD resources, including uplink resources 716 and downlink resources 717 and 718 similar to the resource allocation described in relation to FIG. 5. Graph 712 illustrates uplink signal power over frequency indicating CLI 714 from the uplink signals leaking outside of the uplink frequency range (e.g., UL resources 716) into downlink frequency resources (e.g., DL resources 717 and 718) provided in the sub-band full-duplex resources 710. Similarly, diagram 720 illustrates a set of IBFD resources including uplink resources 726 and downlink resources 727. Graph 722 illustrates uplink signal power over frequency indicating CLI 725 in a set of overlapping uplink and downlink resources and CLI leakage 724 based on the uplink signal leaking outside of the uplink frequency range (e.g., UL resources 726) provided in the IBFD resources into downlink frequency resources (e.g., DL resources 727).

A base station may configure a UE to transmit a sounding reference signal (SRS) as an uplink reference signal. The base station may use the SRS transmitted by the UE to measure channel quality for an uplink path of the UE. The base station may configure the UE to transmit the SRS in SRS resources in time and frequency.

For individual SRS configurations, the SRS frequency domain (e.g., a frequency range for SRS transmissions/measurements) may be defined in reference to an active BWP part at each individual UE. An SRS frequency domain configuration for individual SRS configuration may indicate a frequency starting point k₀ (i.e., the lowest RE) of the SRS that may be defined based on a combination of three frequency offsets (f₁+f₂+f₃). The first frequency offset, f₁ is related to frequency hopping and may have a granularity of 4 RBs. The second frequency offset, f₂, is the RB level shift, it has a granularity of 1 RB. The third frequency offset, f₃, is a RE level shift. With the three frequency offsets, a network (e.g., a base station) may configure the starting position of SRS at any RE in any RB within an active BWP associated with the SRS transmitting UE.

In some aspects, the second offset is equal to n_{shift} RBs. n_{shift} determines the selection of one of two options for the frequency reference point. Given a first variable, N_{BWP}^{start}, that is defined as the lowest frequency RB of the BWP in the cell and a common RB 0 that is the lowest frequency RB of the cell, if N_{BWP}^{start}≤n_{shift} the frequency reference point is subcarrier 0 in common resource block 0 (Option 1), otherwise the frequency reference point is the lowest subcarrier of the BWP (Option 2). In some aspects, the n_{shift} has a limited value range that allows for a maximum shift of 268 RBs which corresponds to about 50 MHz for 15 kHz SCS. If the cell has a carrier bandwidth wider than this range, the network may be unable to configure SRS in the full bandwidth if subcarrier 0 in common RB 0 is used as the reference point. In the individual SRS configurations, it is possible that depending on the BWP configuration, some UE may use option 1 and some UE may use option 2. For UEs using option 2, the same SRS configuration may also result in different SRS transmission due to different BWP configuration.

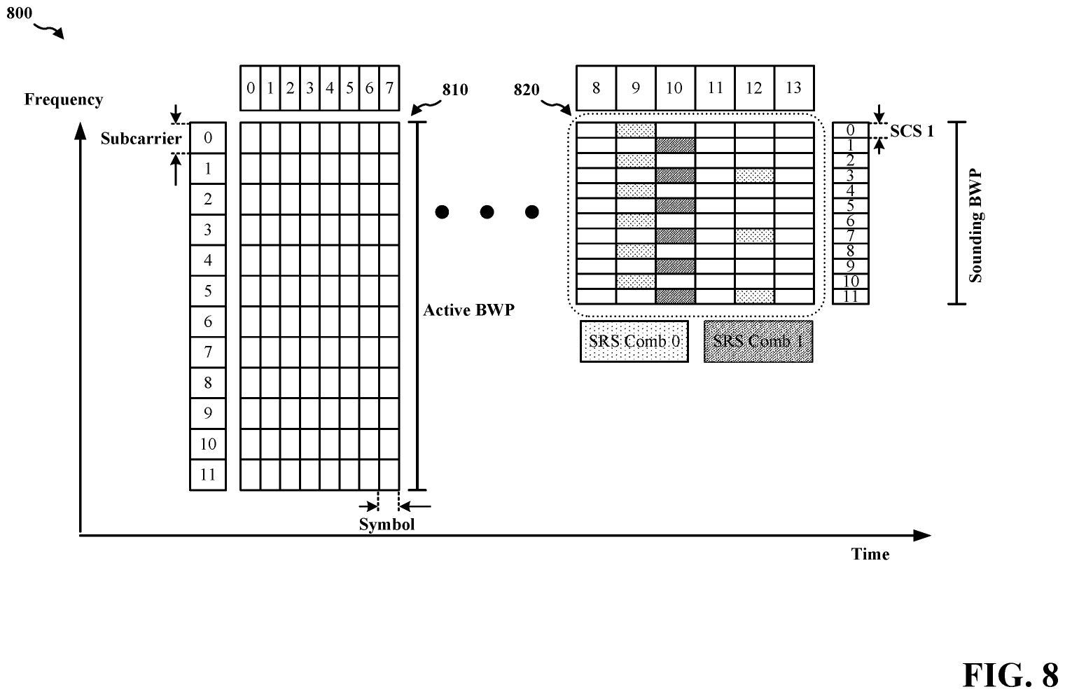

FIG. 8 illustrates an example a set of SRS resources 800 that may be configured for a UE. A particular UE may use a first set of UL/DL resources 810 for data or control and a second set of SRS resources 820 for transmission of the SRS. The SRS may be mapped to physical resources in a resource block, in some aspects. The SRS may span up to four symbols in the last 6 symbols of a slot and may be configured in frequency with a comb offset (e.g., comb-2 and/or comb-4). The SRS may further be configured to be one of periodic, aperiodic, or semi-persistent. A periodic SRS configuration may include a periodicity, a slot offset, and/or a frequency hopping pattern. A SRS configuration may further include a sounding bandwidth (or BWP) that may be the same as the active bandwidth (or BWP) (not illustrated in FIG. 8) or may be different from an active bandwidth (or BWP) as illustrated in FIG. 8. FIG. 8 illustrates a sounding bandwidth that is included within the active bandwidth, but the sounding bandwidth, in some aspects, may not overlap with, or may only partially overlap with, the active bandwidth. The SRS configuration may include a frequency hopping pattern for the UE to apply when transmitting the SRS in the configured resources.

The base station configures a UE specific SRS configuration, e.g., as part of a BWP configuration, in order to measure the uplink channel characteristics for the particular UE. In some aspects, a UE that is experiencing interference from another UE may provide a CLI measurement to a base station in L3 reporting that is based on an SRS transmission from an interfering UE. In order for the interfered UE to measure the CLI, the interfered UE may be configured with a ZP-SRS as a periodic measurement resource to measure the SRS of the interfering UE. In order to enable the UE to provide the report, the base station will configure the configurations of the two UEs to align, e.g., the SRS resources configured for the interfering UE to align with the ZP-SRS measurement resources configured for the interfered UE. As the SRS configuration is UE specific, the base station may configure pairs of configurations for each set of UEs that may experience CLI. A single UE may be configured with multiple configurations, or multiple sets of resources, in order to measure SRS transmissions from different UEs.

Aspects presented herein provide for a cell level CLI-SRS configuration that may enable CLI measurements based on SRS between a plurality of different UEs. The cell level CLI-SRS configuration may enable the CLI measurements and reporting with reduced configuration signaling overhead and/or management from the base station. The cell level CLI SRS configuration may include aspects that are applicable for both the NZP CLI SRS, e.g., SRS resources for SRS transmission, and for ZP CLI SRS, e.g., measurement resources to receive and measure the SRS. To allow cell level CLI-SRS, in some aspects, a common reference frequency that is not dependent on the active BWP at each UE is used for multiple UEs for which the cell level CLI-SRS a group-based SRS configuration is applied.

In some aspects, a base station may flexibly trigger an aperiodic-SRS (A-SRS) based on a RRC configuration including a list of available slot ‘t’ values via an DCI indication of a particular ‘t’ value. A slot may be available for A-SRS if there are UL/Flexible symbols (e.g., a symbol in resources 710 of FIG. 7) that accommodate all SRS resources of a triggered SRS set. For example, in some aspects, DCI that schedules a PDSCH (or a PUSCH) and DCI 0_1 (or DCI 0_2) without data and without CSI request may indicate T by adding a new configurable DCI field (e.g., up to 2 bits). In some aspects, the indication is not unless there are multiple candidate values of ‘t’ configured.

In some aspects of wireless communication, CLI-SRS resources are configured by a base station for each of a plurality of UEs served by the base station. In order to measure CLI, CLI-SRS resources, in some aspects, are aligned for different UEs in the plurality of UEs. A base station may align a zero-power (ZP) CLI-SRS at a first UE with a non-ZP-CLI-SRS (e.g., a SRS transmission) at a second UE. Some aspects provide group-based (e.g., cell level, zone-based, or aggressor-based) CLI-SRS configurations that reduce management overhead associated with aligning CLI-SRS resources at different UEs independently. The group-based CLI-SRS resources may be used in association with communication between a UE and a base station or in association with sidelink communication. In some aspects, the cell level CLI-SRS may be for Uu interference measurements, e.g., of an uplink SRS transmission. In some aspects, the cell level CLI-SRS may be configured to UEs to use for sidelink interference measurements, e.g., of a sidelink SRS transmission.

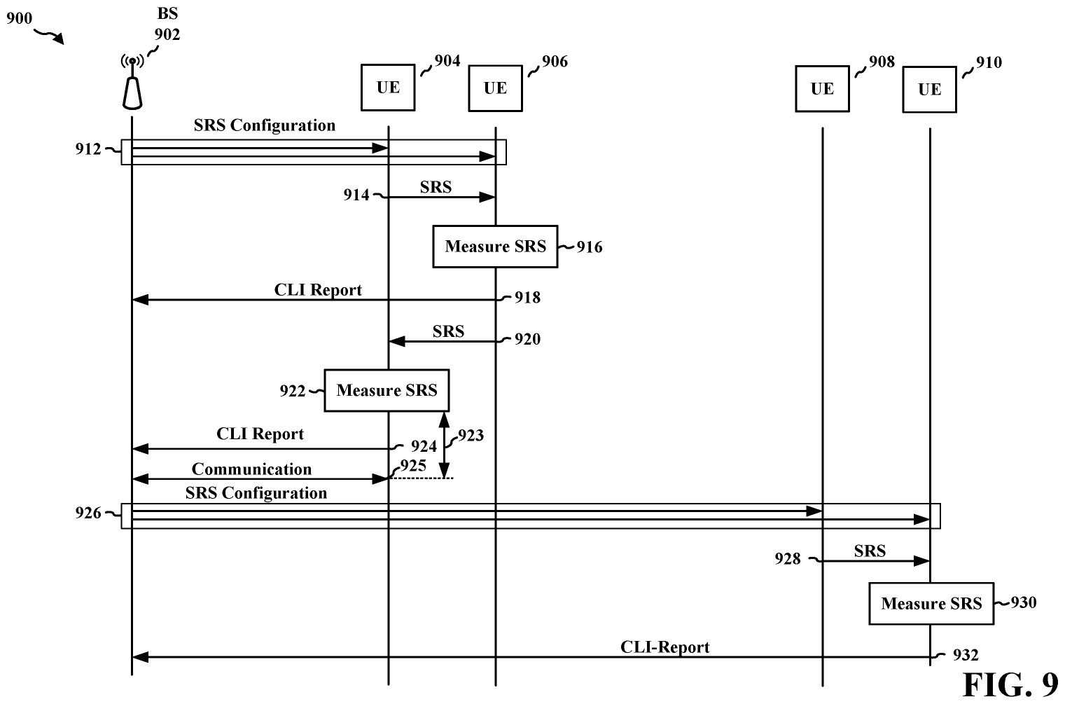

FIG. 9 is a call flow diagram 900 illustrating a set of operations associated with CLI measurement based on a cell-level SRS configuration. The BS 902 may transmit, and UEs 904 and 906 may receive, SRS configuration 912 that indicates a set of common (e.g., cell-level or zone-level) SRS resources. The SRS configuration 912 may indicate zero-power (ZP) CLI-SRS resources that may be used by at least one UE for measuring CLI based on SRS received from at least one other UE and non-ZP CLI-SRS resources that may be used for transmitting SRS for CLI measurement at the at least one other UE. Although the configuration 912 is illustrated with two lines, the configuration may be included in signaling that is received in common by the UEs 904 and 906. In some aspects, the configuration 912 may be included in cell level signaling that is receivable by each UE in the cell, e.g., such as a cell level RRC configuration. Thus, the configuration may be used in common by multiple UEs. In some aspects, the configuration may be used in common by any UE in the cell. In some aspects, the SRS configuration 912 may indicate different ZP-CLI-SRS resources and NZP-CLI-SRS resources for the UE 904 and the UE 906. For example, the SRS configuration 912 may indicate a particular resource as a ZP-CLI-SRS resource for a first UE (e.g., UE 904), while indicating the particular resource as an NZP-CLI-SRS resource for a second UE (e.g., UE 906), such that the second UE transmits a SRS transmission via the particular resource and the first UE receives the SRS transmission for measuring the CLI via the particular resource.

The SRS configuration 912 may indicate a SCS of the first set of common SRS resources and a reference frequency (e.g., used to indicate a frequency range and/or bandwidth) associated with the first set of common SRS resources. In some aspects, the SRS configuration 912 may provide SRS and reference frequency information for the CLI-SRS configuration by including a set of fields in an information element (IE) of the RRC associated with the SRS for a CLI measurement, e.g., dedicated for the CLI-SRS. In some aspects, the RRC configuration for the CLI-SRS may include one or more of a set of fields include a reference SCS field (e.g., which may be referred to by a name such as “Ref-SCS-CLI-SRS” or by another name) and a reference frequency field (e.g., which may be referred to by a name such as “Ref-freq-CLI-SRS” or by another name). The reference frequency may correspond to a starting resource block (RB) for the sounding bandwidth of the CLI-SRS, for example.

In some aspects, rather than having a reference frequency indicated to the UE, the starting RB of the sounding bandwidth for the CLI-SRS may be indicated or derived in a different manner than a UE specific SRS reference frequency. As an example, a value range of n_shift may cover an entire bandwidth (e.g., a carrier bandwidth of 100 MHz for FR1) for the CLI-SRS.

In some aspects, the RRC configuration of the CLI-SRS may include an indication of a reference BWP for derivation of the SCS and the reference frequency. Each UE may then use the reference BWP to derive an SCS and/or reference frequency for the CLI-SRS. In some aspects, the base station may align, e.g., configure the same or overlapping reference BWPs, for different UEs so that the UEs will derive the same SCS or same reference frequency.

In some aspects, an active BWP for communication may be the same as a BWP associated with the first set of common resources for the SRS for the CLI measurement and may be associated with a same SCS. An active BWP for communication, in some aspects, may be the same as a BWP associated with the first set of common resources for the SRS for the CLI measurement and may be associated with a different SCS than the first set of common resources. In some aspects, the active BWP for communication may be different than a BWP associated with the first set of common resources for the SRS for the CLI measurement and may be associated with an SCS that is the same as, or that is different from, an SCS associated with the first set of common resources. In aspects in which either (1) an active BWP is different from a BWP associated with the first set of common resources or (2) a SCS associated with the active BWP is different than a SCS associated with the first set of common resources, the SRS configuration 912 may include an indication of a minimum time gap (e.g., 723) between a communication 925 in the active BWP and a SRS transmission or a SRS measurement 922 in the BWP associated with the first set of common resources. Although the illustration of an example time gap 923 in FIG. 9 is shown between the SRS measurement, at 922, and the communication 925 following the SRS measurement, a time gap may similarly be between communication prior to the SRS measurement 922 and/or for communication before or after the SRS transmission 914.

In some aspects, a UE (e.g., UEs 904 and 906) may skip an uplink transmission or an SRS measurement if a time duration between the uplink transmission and transmission/measurement of the common-SRS is less than a minimum time gap. In some aspects, the SRS measurement may be skipped regardless of a minimum time gap. The minimum time gap may be indicated in the SRS configuration, in some aspects. As an example, the UE may skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement. In some aspects, which of the common-SRS operation or the UL transmission is skipped may be based on a priority assigned to each of the common-SRS operation or the UL transmission.

In some aspects, the SRS configuration 912 indicates a spatial relation for the first set of common resources based on a quasi co-location (QCL) relationship (e.g., QCL type D) to a reference signal for a cell or that is common to the first UE (e.g., UE 904) and the second UE (e.g., UE 906). The reference signal for the QCL relationship may be a cell level reference signal (e.g., a cell wide RS) such as an SSB or other reference signal that is common to the UEs in the cell. The reference signal for the QCL relationship may be a CSI-RS that is configured for multiple UEs, e.g., the multiple UEs that are intended to transmit/measure CLI with each other.

The SRS configuration 912, in some aspects, may include an indication of a set of common power control parameters associated with the first set of common resources. The indicated power control parameters may include (e.g., reference) power control parameters associated with a UEs PUSCH power control (e.g., have no separate power control loop for the CLI-SRS) or may include separate power control parameters (e.g., an alpha, p0, and pathlossreferenceRS) for a separate power control loop for the CLI-SRS.

Based on the SRS configuration 912, the first UE 904 may transmit, and the UE 906 may receive, a first SRS transmission 914 via a SRS resource configured (1) as a NZP-CLI-SRS resource at the first UE 904 and (2) as a ZP-CLI-SRS resource at the UE 906. The UE 904 and the UE 906 may identify particular resources as NZP-CLI-SRS or ZP-CLI-SRS based on a UE identifier or other UE-specific value. The UE 906 may then measure, at 916, the SRS transmission 914 received from the UE 904. The UE 906 may then transmit a CLI report 918 regarding the SRS transmission from at least the UE 904.

Similarly, the UE 906 may transmit, and the UE 904 may receive, a second SRS transmission 920 via a SRS resource configured (1) as a ZP-CLI-SRS resource at the first UE 904 and (2) as a NZP-CLI-SRS resource at the UE 906. The UE 904 may then measure, at 922, the SRS transmission 920 received from the UE 906. The UE 904 may then transmit a CLI report 924 regarding the SRS transmission from at least the UE 904.

The BS 902 may further transmit, and UEs 908 and 910 may receive, SRS configuration 926 that indicates a second set of group-level (e.g., cell-level or zone-level) SRS resources. The SRS configuration 926 may indicate zero-power (ZP) CLI-SRS resource used by at least one UE for measuring CLI based on SRS received from at least one other UE and non-ZP CLI-SRS resources for transmitting SRS to at least one other UE for CLI measurement at the at least one other UE. The SRS configuration 926 may indicate different ZP-CLI-SRS resources and NZP-CLI-SRS resources for the UE 908 and the UE 910. For example, the SRS configuration 926 may indicate a particular resource as a ZP-CLI-SRS resource for a third UE (e.g., UE 908), while indicating the particular resource as a NZP-CLI-SRS resource for a fourth UE (e.g., UE 910), such that the third UE 908 transmits a SRS transmission via the particular resource and the fourth UE 910 receives the SRS transmission for measuring the CLI via the particular resource.

Based on the SRS configuration 926, the third UE 908 may transmit, and the fourth UE 910 may receive, a third SRS transmission 928 via a SRS resource configured (1) as a NZP-CLI-SRS resource at the third UE 908 and (2) as a ZP-CLI-SRS resource at the fourth UE 910. The third UE 908 and the fourth UE 910 may identify particular resources as NZP-CLI-SRS or ZP-CLI-SRS based on a UE identifier or other UE-specific value. The fourth UE 910 may then measure, at 930, the SRS transmission 928 received from the third UE 908. The fourth UE 910 may then transmit a CLI report 932 regarding the SRS transmission from at least the third UE 908.

In some aspects the SRS transmission and measurement may be for sidelink, e.g., for CLI measurements relating to sidelink communication between UEs. The base station 902 may provide a configuration for the CLI-SRS, and one or more UEs may use the CLI-SRS resources to transmit a sidelink SRS transmission and/or to measure interference from an SRS transmission to sidelink communication. Aspects of sidelink communication are described in connection with FIG. 1 and FIG. 18, for example.

Aspects presented herein may enable a CLI-SRS configuration that is common to multiple UEs in a cell. In some aspects, the CLI-SRS configuration may be common to each UE in a cell, e.g., a cell wide configuration. In other aspects, the CLI-RS configuration may be common to multiple levels that are a subset of UEs served by the cell.

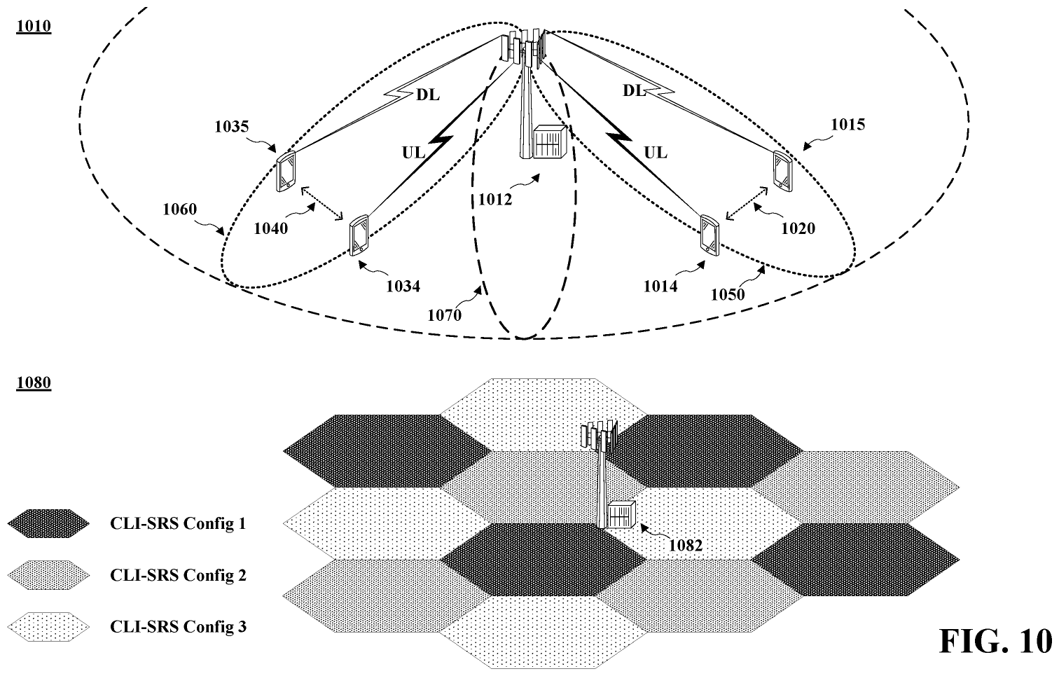

FIG. 10 illustrates example sub-cell-level CLI-SRS configuration implementations. Diagram 1010 illustrates a first base station 1012 in FD communication with two pairs of UEs (e.g., UEs 1014 and 1015 and UEs 1034 and 1035). Each pair of UEs (e.g., UEs 1014 and 1015 and UEs 1034 and 1035) may experience CLI (e.g., CLI 1020 and CLI 1040). Each pair of UEs may be associated with a different synchronization signal block (SSB) index and each SSB index may be associated with a CLI-SRS configuration. Each SSB index may be associated with a beam direction (e.g., beam directions 1050, 1060, or 1070) and adjacent beam directions may be associated with different CLI-SRS configurations, while a particular CLI-SRS configuration may be associated with each of a set of non-adjacent beam directions.

For example, beam directions 1050 and 1060 may be associated with a same CLI-SRS configuration while beam direction 1070 may be associated with a different CLI-SRS configuration. Each CLI-SRS configuration, in some aspects, includes a plurality of SRS resources to support a plurality of UEs using a same CLI-SRS configuration. The CLI-SRS configuration that is common to UEs 1014 and 1015 and/or common to UEs 1034 and 1035 may allow the UEs to measure CLI 1020 or 1040. The different CLI-SRS configuration common to UEs associated with beam direction 1070 (UEs not shown) may indicate common SRS resources for CLI measurement at UEs associated with the beam direction 1070. The CLI-SRS configuration common to UEs associated with beam direction 1070, in some aspects, may be configured such that the SRS transmissions from UEs associated with beam directions 1050 and 1060 do not interfere with CLI measurements made by UEs associated with beam direction 1070 and vice versa.

Similarly, diagram 1080 illustrates a set of common SRS resource configurations (e.g., CLI-SRS Config 1 to CLI-SRS Config 3) for a zone-based CLI. For example, an area serviced by a base station 1082 may be divided into zones using one of three (or more) CLI-SRS configurations (e.g., CLI-SRS Config 1 to CLI-SRS Config 3). In some aspects, UEs associated with different beam directions (e.g., SSB index values), as in diagram 1010, or in different zones, as in diagram 1080 may be scheduled by the base station for simultaneous UL and DL transmission/reception.

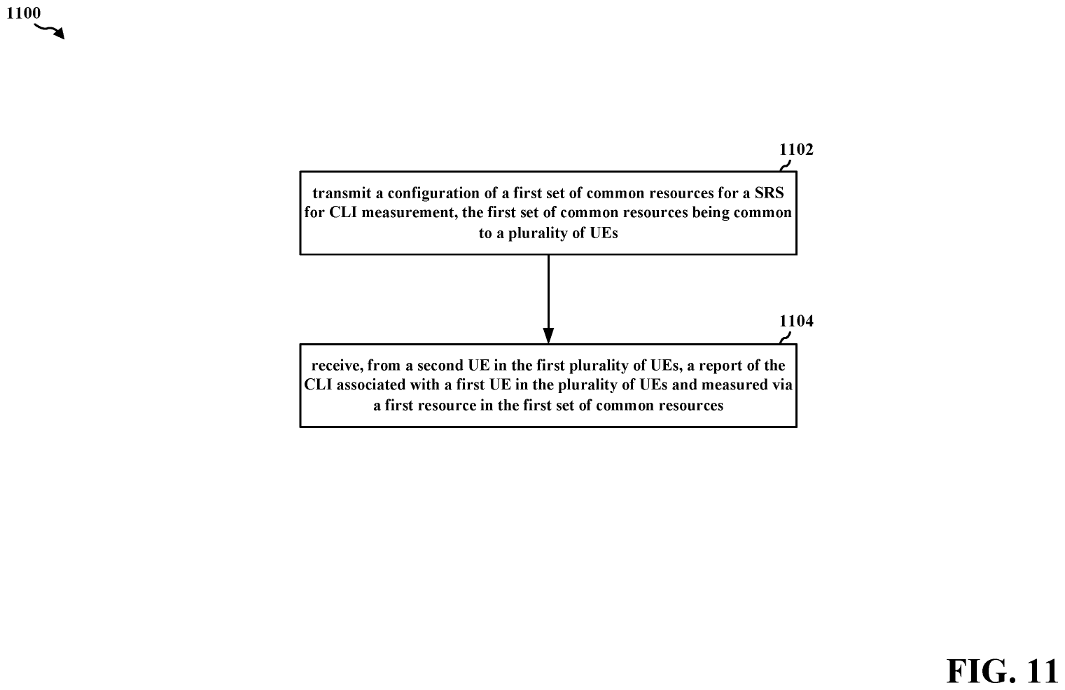

FIG. 11 is a flowchart 1100 of a method of wireless communication. The method may be performed by a base station (e.g., the base station 102/180, 902, 1012, 1082; the apparatus 1702). At 1102, the base station may transmit, and at least one UE may receive, a configuration of a first set of common resources for a SRS for CLI measurement, the first set of common resources being common to a first plurality of UEs. For example, 1102 may be performed by CLI-SRS configuration component 1740. The configuration may indicate a sub-carrier spacing of the first set of common resources and a reference frequency associated with the first set of common resources. In some aspects, the configuration includes one of (1) a set of fields in an information element associated with the SRS for the cross-link interference measurement, the set of fields including a reference sub-carrier spacing field and a reference frequency field, (2) an indication of the sub-carrier spacing of the first set of common resources and an indication of a frequency shift associated with the reference frequency, or (3) an indication of a reference BWP for derivation of the sub-carrier spacing and the reference frequency. For example, referring to FIG. 9, the base station 902 may transmit, and UE 904 or UE 906 may receive, a SRS configuration 912.

In some aspects, an active BWP for communication may be the same as a BWP associated with the first set of common resources for the SRS for the CLI measurement and may be associated with a same SCS. An active BWP for communication, in some aspects, may be the same as a BWP associated with the first set of common resources for the SRS for the CLI measurement and may be associated with a different SCS than the first set of common resources. In some aspects, the active BWP for communication is different than a BWP associated with the first set of common resources for the SRS for the CLI measurement and may be associated with an SCS that is the same as, or that is different from, an SCS associated with the first set of common resources. In aspects in which either (1) an active BWP is different from a BWP associated with the first set of common resources or (2) a SCS associated with the active BWP is different than a SCS associated with the first set of common resources, the configuration may include an indication of a minimum time gap between a communication in the active BWP and a SRS transmission or a SRS measurement in the BWP associated with the first set of common resources.

The configuration may also include an indication for the plurality of UEs to skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement. In some aspects, the configuration indicates a spatial relation for the set of common resources based on a QCL relationship to a reference signal for a cell or that is common to a first UE and a second UE. The configuration, in some aspects, may include an indication of a set of common power control parameters associated with the first set of common resources. The indicated power control parameters may include (e.g., reference) power control parameters associated with a UEs PUSCH power control (e.g., have no separate power control loop for the CLI-SRS) or may include separate power control parameters (e.g., an alpha, p0, and pathlossreferenceRS) for a separate power control loop for the CLI-SRS.

At 1104, the base station may receive, from a second UE in the first plurality of UEs, a report of the CLI associated with a first UE in the first plurality of UEs and measured via a first resource in the first set of common resources. For example, 1104 may be performed by CLI-SRS report component 1742. The report of the CLI associated with the first UE in the first plurality of UEs, in some aspects, may be based on a SRS transmitted from the first UE and received at the second UE based on the CLI-SRS configuration transmitted at 1102. For example, referring to FIG. 9, the base station 902 may receive CLI report 918.

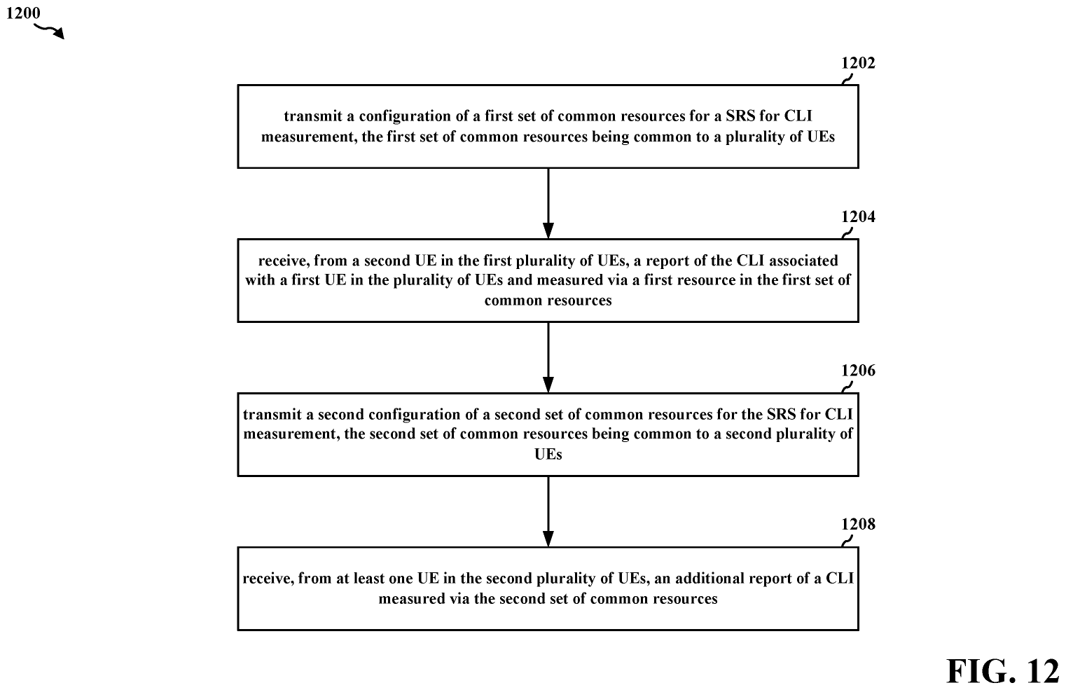

FIG. 12 is a flowchart 1200 of a method of wireless communication. The method may be performed by a base station (e.g., the base station 102/180, 902, 1012, 1082; the apparatus 1702). At 1202, the base station may transmit, and at least one UE may receive, a configuration of a first set of common resources for a SRS for CLI measurement, the first set of common resources being common to a first plurality of UEs. For example, 1202 may be performed by CLI-SRS configuration component 1740. The configuration may indicate a sub-carrier spacing of the first set of common resources and a reference frequency associated with the first set of common resources. In some aspects, the configuration includes one of (1) a set of fields in an information element associated with the SRS for the cross-link interference measurement, the set of fields including a reference sub-carrier spacing field and a reference frequency field, (2) an indication of the sub-carrier spacing of the first set of common resources and an indication of a frequency shift associated with the reference frequency, or (3) an indication of a reference BWP for derivation of the sub-carrier spacing and the reference frequency. For example, referring to FIG. 9, the base station 902 may transmit, and UE 904 or UE 906 may receive, a SRS configuration 912.

In some aspects, an active BWP for communication may be the same as a BWP associated with the first set of common resources for the SRS for the CLI measurement and may be associated with a same SCS. An active BWP for communication, in some aspects, may be the same as a BWP associated with the first set of common resources for the SRS for the CLI measurement and may be associated with a different SCS than the first set of common resources. In some aspects, the active BWP for communication is different than a BWP associated with the first set of common resources for the SRS for the CLI measurement and may be associated with an SCS that is the same as, or that is different from, an SCS associated with the first set of common resources. In aspects in which either (1) an active BWP is different from a BWP associated with the first set of common resources or (2) a SCS associated with the active BWP is different than a SCS associated with the first set of common resources, the configuration may include an indication of a minimum time gap between a communication in the active BWP and a SRS transmission or a SRS measurement in the BWP associated with the first set of common resources.

The configuration may also include an indication for the plurality of UEs to skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement. In some aspects, the configuration indicates a spatial relation for the set of common resources based on a QCL relationship to a reference signal for a cell or that is common to a first UE and a second UE. The configuration, in some aspects, may include an indication of a set of common power control parameters associated with the first set of common resources. The indicated power control parameters may include (e.g., reference) power control parameters associated with a UEs PUSCH power control (e.g., have no separate power control loop for the CLI-SRS) or may include separate power control parameters (e.g., an alpha, p0, and pathlossreferenceRS) for a separate power control loop for the CLI-SRS.

At 1204, the base station may receive, from a second UE in the first plurality of UEs, a report of the CLI associated with a first UE in the first plurality of UEs and measured via a first resource in the first set of common resources. For example, 1204 may be performed by CLI-SRS report component 1742. The report of the CLI associated with the first UE in the first plurality of UEs, in some aspects, may be based on a SRS transmitted from the first UE and received at the second UE based on the CLI-SRS configuration transmitted at 1202. For example, referring to FIG. 9, the base station 902 may receive CLI report 918.

At 1206, the base station may transmit, and at least one UE may receive, a configuration of a second set of common resources for a SRS for CLI measurement, the second set of common resources being common to a second plurality of UEs. For example, 1202 may be performed by CLI-SRS configuration component 1740. The configuration may indicate a sub-carrier spacing of the second set of common resources and a reference frequency associated with the second set of common resources. In some aspects, the configuration includes one of (1) a set of fields in an information element associated with the SRS for the cross-link interference measurement, the set of fields including a reference sub-carrier spacing field and a reference frequency field, (2) an indication of the sub-carrier spacing of the second set of common resources and an indication of a frequency shift associated with the reference frequency, or (3) an indication of a reference BWP for derivation of the sub-carrier spacing and the reference frequency. For example, referring to FIG. 9, the base station 902 may transmit, and UE 908 or UE 910 may receive, a SRS configuration 926.

In some aspects, an active BWP for communication may be the same as a BWP associated with the second set of common resources for the SRS for the CLI measurement and may be associated with a same SCS. An active BWP for communication, in some aspects, may be the same as a BWP associated with the second set of common resources for the SRS for the CLI measurement and may be associated with a different SCS than the second set of common resources. In some aspects, the active BWP for communication is different than a BWP associated with the second set of common resources for the SRS for the CLI measurement and may be associated with an SCS that is the same as, or that is different from, an SCS associated with the second set of common resources. In aspects in which either (1) an active BWP is different from a BWP associated with the second set of common resources or (2) a SCS associated with the active BWP is different than a SCS associated with the second set of common resources, the configuration may include an indication of a minimum time gap between a communication in the active BWP and a SRS transmission or a SRS measurement in the BWP associated with the second set of common resources.

The configuration may also include an indication for the second plurality of UEs to skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement. In some aspects, the configuration indicates a spatial relation for the second set of common resources based on a QCL relationship to a reference signal for a cell or that is common to a third UE and a fourth UE. The configuration, in some aspects, may include an indication of a set of common power control parameters associated with the second set of common resources. The indicated power control parameters may include (e.g., reference) power control parameters associated with a UEs PUSCH power control (e.g., have no separate power control loop for the CLI-SRS) or may include separate power control parameters (e.g., an alpha, p0, and pathlossreferenceRS) for a separate power control loop for the CLI-SRS.

At 1208, the base station may receive, from at least one UE in the second plurality of UEs, an additional report of a CLI measured via the second set of common resources. For example, 1208 may be performed by CLI-SRS configuration component 1740. The additional report of the CLI, in some aspects, may be based on a SRS transmitted from a UE in the second plurality of UEs and received at the at least one UE in the second plurality of UEs based on the CLI-SRS configuration transmitted at 1206. For example, referring to FIG. 9, the base station 902 may receive CLI report 932.

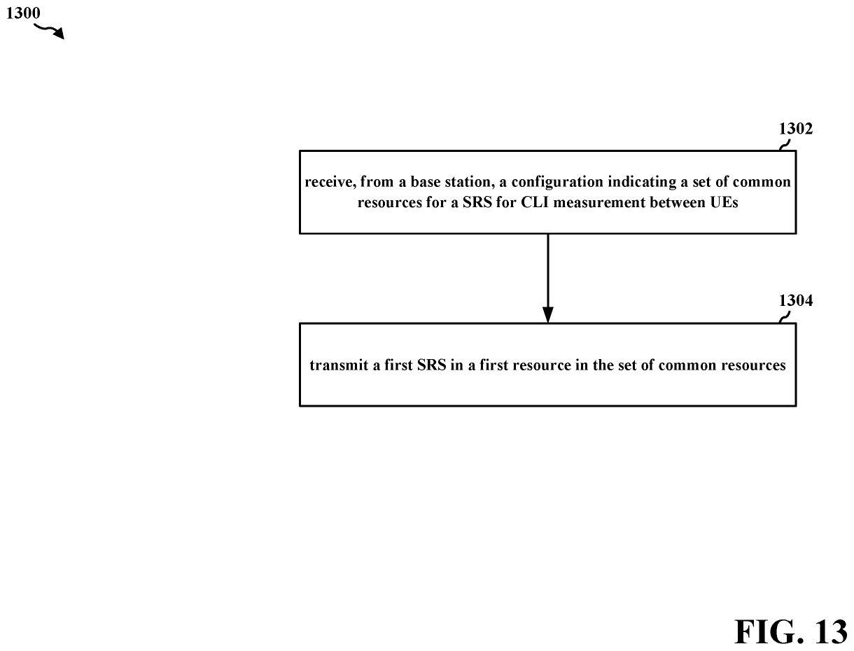

FIG. 13 is a flowchart 1300 of a method of wireless communication. The method may be performed by a UE (e.g., the UE 104, 904, 906, 908, 910, 1014, 1015, 1034, 1035; the apparatus 1602). At 1302, the UE may receive, from a base station, a configuration indicating a set of common resources for a SRS for CLI measurement between UEs. For example, 1302 may be performed by CLI-SRS configuration component 1640. The configuration may indicate a sub-carrier spacing of the first set of common resources and a reference frequency associated with the first set of common resources. In some aspects, the configuration includes one of (1) a set of fields in an information element associated with the SRS for the cross-link interference measurement, the set of fields including a reference sub-carrier spacing field and a reference frequency field, (2) an indication of the sub-carrier spacing of the first set of common resources and an indication of a frequency shift associated with the reference frequency, or (3) an indication of a reference BWP for derivation of the sub-carrier spacing and the reference frequency. For example, referring to FIG. 9, the UE 904 may receive, a SRS configuration 912 from base station 902.

In some aspects, an active BWP for communication may be the same as a BWP associated with the first set of common resources for the SRS for the CLI measurement and may be associated with a same SCS. An active BWP for communication, in some aspects, may be the same as a BWP associated with the first set of common resources for the SRS for the CLI measurement and may be associated with a different SCS than the first set of common resources. In some aspects, the active BWP for communication is different than a BWP associated with the first set of common resources for the SRS for the CLI measurement and may be associated with an SCS that is the same as, or that is different from, an SCS associated with the first set of common resources. In aspects in which either (1) an active BWP is different from a BWP associated with the first set of common resources or (2) a SCS associated with the active BWP is different than a SCS associated with the first set of common resources, the configuration may include an indication of a minimum time gap between a communication in the active BWP and a SRS transmission or a SRS measurement in the BWP associated with the first set of common resources.

The configuration may also include an indication for the plurality of UEs to skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement. In some aspects, the configuration indicates a spatial relation for the set of common resources based on a QCL relationship to a reference signal for a cell or that is common to a first UE and a second UE. The configuration, in some aspects, may include an indication of a set of common power control parameters associated with the first set of common resources. The indicated power control parameters may include (e.g., reference) power control parameters associated with a UEs PUSCH power control (e.g., have no separate power control loop for the CLI-SRS) or may include separate power control parameters (e.g., an alpha, p0, and pathlossreferenceRS) for a separate power control loop for the CLI-SRS.

At 1304, the UE may transmit a first SRS in a first resource in the set of common resources to other UEs in the first plurality of UEs. For example, 1304 may be performed by CLI-SRS transmission component 1642. The first SRS transmission may be received at another UE for measuring CLI between the UE and the other UE based on the configuration received, at 1302, from the base station. For example, referring to FIG. 9, the UE 904 may transmit SRS transmission 914.

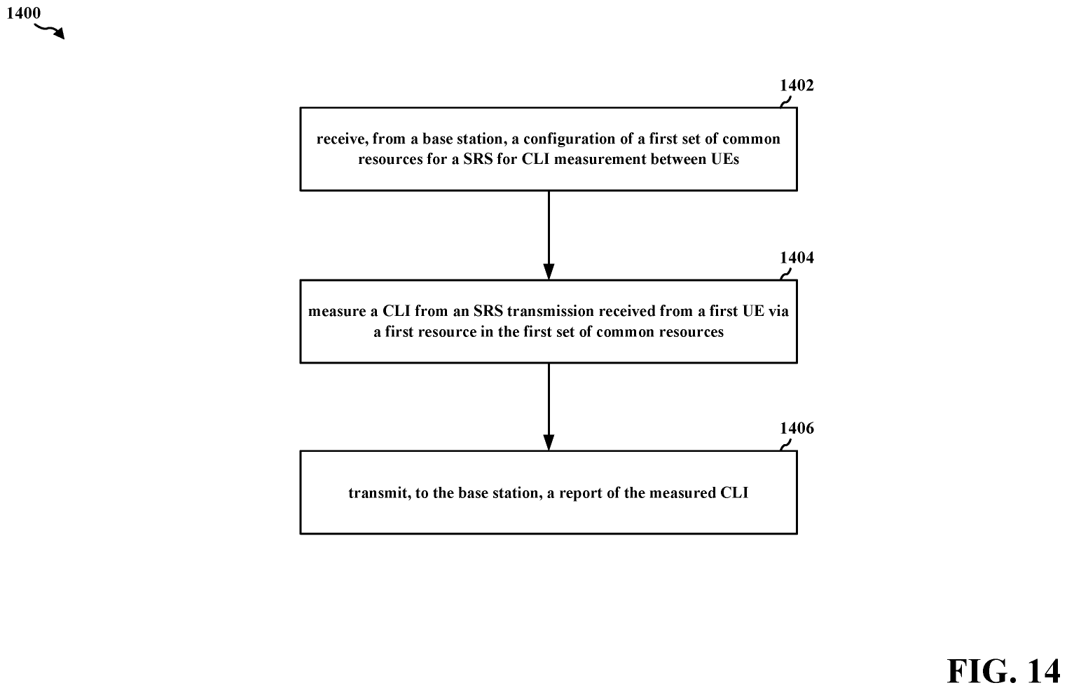

FIG. 14 is a flowchart 1400 of a method of wireless communication. The method may be performed by a UE (e.g., the UE 104, 904, 906, 908, 910, 1014, 1015, 1034, 1035; the apparatus 1602). At 1402, the UE may receive, from a base station, a configuration indicating a set of common resources for a SRS for CLI measurement between UEs. For example, 1402 may be performed by CLI-SRS configuration component 1640. The configuration may indicate a sub-carrier spacing of the first set of common resources and a reference frequency associated with the first set of common resources. In some aspects, the configuration includes one of (1) a set of fields in an information element associated with the SRS for the cross-link interference measurement, the set of fields including a reference sub-carrier spacing field and a reference frequency field, (2) an indication of the sub-carrier spacing of the first set of common resources and an indication of a frequency shift associated with the reference frequency, or (3) an indication of a reference BWP for derivation of the sub-carrier spacing and the reference frequency. For example, referring to FIG. 9, the UE 906 may receive, a SRS configuration 912 from base station 902.

In some aspects, an active BWP for communication may be the same as a BWP associated with the first set of common resources for the SRS for the CLI measurement and may be associated with a same SCS. An active BWP for communication, in some aspects, may be the same as a BWP associated with the first set of common resources for the SRS for the CLI measurement and may be associated with a different SCS than the first set of common resources. In some aspects, the active BWP for communication is different than a BWP associated with the first set of common resources for the SRS for the CLI measurement and may be associated with an SCS that is the same as, or that is different from, an SCS associated with the first set of common resources. In aspects in which either (1) an active BWP is different from a BWP associated with the first set of common resources or (2) a SCS associated with the active BWP is different than a SCS associated with the first set of common resources, the configuration may include an indication of a minimum time gap between a communication in the active BWP and a SRS transmission or a SRS measurement in the BWP associated with the first set of common resources.

The configuration may also include an indication for the plurality of UEs to skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement. In some aspects, the configuration indicates a spatial relation for the set of common resources based on a QCL relationship to a reference signal for a cell or that is common to a first UE and a second UE. The configuration, in some aspects, may include an indication of a set of common power control parameters associated with the first set of common resources. The indicated power control parameters may include (e.g., reference) power control parameters associated with a UEs PUSCH power control (e.g., have no separate power control loop for the CLI-SRS) or may include separate power control parameters (e.g., an alpha, p0, and pathlossreferenceRS) for a separate power control loop for the CLI-SRS.

At 1404, the UE may measure a CLI from a SRS transmission received from a first UE via a first resource in the first set of common resources. For example, 1404 may be performed by CLI-SRS reporting component 1644. The SRS transmission received from the first UE may be via a ZP-CLI-SRS resource for the UE indicated in the configuration received at 1402. Measuring, at 1404, the CLI may include measuring a reference signal received power (RSRP) or other measure of signal strength that is relevant to measuring interference at the UE. For example, referring to FIG. 9, the UE 906 may measure, at 916 the SRS transmission 914 transmitted by the UE 904 based on the SRS configuration 912 transmitted by the base station 902 and received at the UEs 904 and 906.

Finally, at 1406, the UE may transmit, to the base station, a report of the measured CLI. For example, 1406 may be performed by CLI-SRS reporting component 1644. The CLI report transmitted at 1406, may indicate a level of CLI from one or more UEs in the first plurality of UEs associated with the set of common resources. For example, referring to FIG. 9, the UE 906 may transmit CLI report 918 to the base station 902.

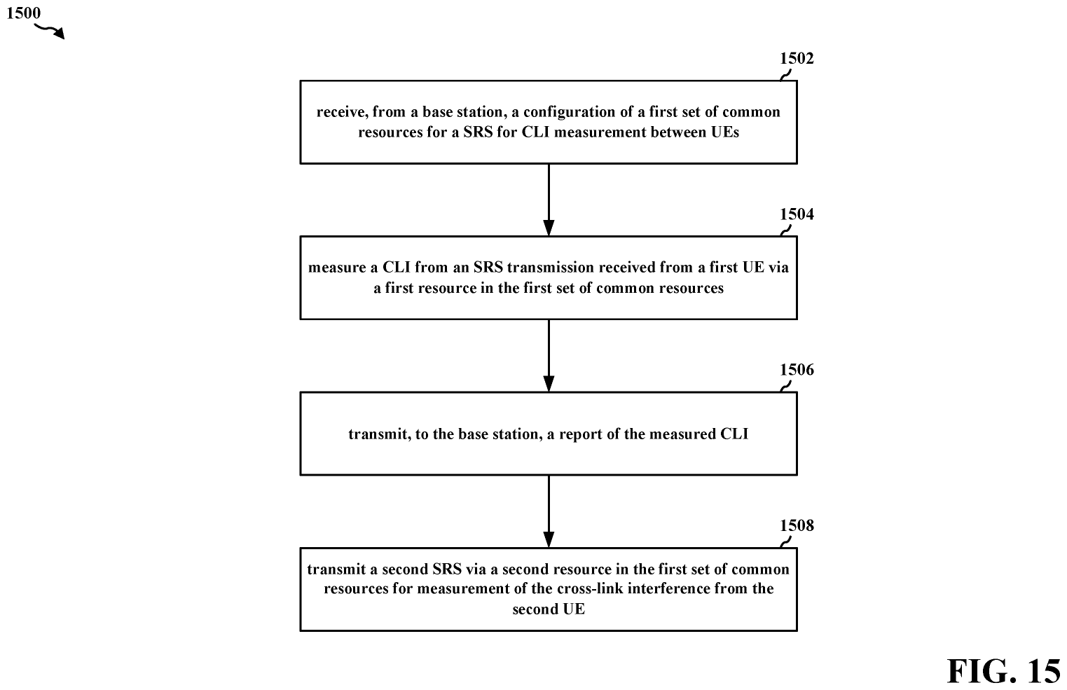

FIG. 15 is a flowchart 1500 of a method of wireless communication. The method may be performed by a UE (e.g., the UE 104, 904, 906, 908, 910, 1014, 1015, 1034, 1035; the apparatus 1602). At 1502, the UE may receive, from a base station, a configuration indicating a set of common resources for a SRS for CLI measurement between UEs. For example, 1502 may be performed by CLI-SRS configuration component 1640. The configuration may indicate a sub-carrier spacing of the first set of common resources and a reference frequency associated with the first set of common resources. In some aspects, the configuration includes one of (1) a set of fields in an information element associated with the SRS for the cross-link interference measurement, the set of fields including a reference sub-carrier spacing field and a reference frequency field, (2) an indication of the sub-carrier spacing of the first set of common resources and an indication of a frequency shift associated with the reference frequency, or (3) an indication of a reference BWP for derivation of the sub-carrier spacing and the reference frequency. For example, referring to FIG. 9, the UE 906 may receive, a SRS configuration 912 from base station 902.

In some aspects, an active BWP for communication may be the same as a BWP associated with the first set of common resources for the SRS for the CLI measurement and may be associated with a same SCS. An active BWP for communication, in some aspects, may be the same as a BWP associated with the first set of common resources for the SRS for the CLI measurement and may be associated with a different SCS than the first set of common resources. In some aspects, the active BWP for communication is different than a BWP associated with the first set of common resources for the SRS for the CLI measurement and may be associated with an SCS that is the same as, or that is different from, an SCS associated with the first set of common resources. In aspects in which either (1) an active BWP is different from a BWP associated with the first set of common resources or (2) a SCS associated with the active BWP is different than a SCS associated with the first set of common resources, the configuration may include an indication of a minimum time gap between a communication in the active BWP and a SRS transmission or a SRS measurement in the BWP associated with the first set of common resources.

The configuration may also include an indication for the plurality of UEs to skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement. In some aspects, the configuration indicates a spatial relation for the set of common resources based on a QCL relationship to a reference signal for a cell or that is common to a first UE and a second UE. The configuration, in some aspects, may include an indication of a set of common power control parameters associated with the first set of common resources. The indicated power control parameters may include (e.g., reference) power control parameters associated with a UEs PUSCH power control (e.g., have no separate power control loop for the CLI-SRS) or may include separate power control parameters (e.g., an alpha, p0, and pathlossreferenceRS) for a separate power control loop for the CLI-SRS.

At 1504, the UE may measure a CLI from a SRS transmission received from a first UE via a first resource in the first set of common resources. For example, 1504 may be performed by CLI-SRS reporting component 1644. The SRS transmission received from the first UE may be via a ZP-CLI-SRS resource for the UE indicated in the configuration received at 1502. Measuring, at 1504, the CLI may include measuring a reference signal received power (RSRP) or other measure of signal strength that is relevant to measuring interference at the UE. For example, referring to FIG. 9, the UE 906 may measure, at 916 the SRS transmission 914 transmitted by the UE 904 based on the SRS configuration 912 transmitted by the base station 902 and received at the UEs 904 and 906.

At 1506, the UE may transmit, to the base station, a report of the measured CLI. For example, 1506 may be performed by CLI-SRS reporting component 1644. The CLI report transmitted at 1506, may indicate a level of CLI from one or more UEs in the first plurality of UEs associated with the set of common resources. For example, referring to FIG. 9, the UE 906 may transmit CLI report 918 to the base station 902.

Finally, at 1508, the UE may transmit a second SRS via a second resource in the set of common resources for measurement of the cross-link interference from the second UE at one or more other UEs in the first plurality of UEs. For example, 1508 may be performed by CLI-SRS transmission component 1642. The second SRS transmission may be received at another UE for measuring CLI between the second UE and the other UE based on the configuration received, at 1502, from the base station. For example, referring to FIG. 9, the UE 906 may transmit SRS transmission 920.

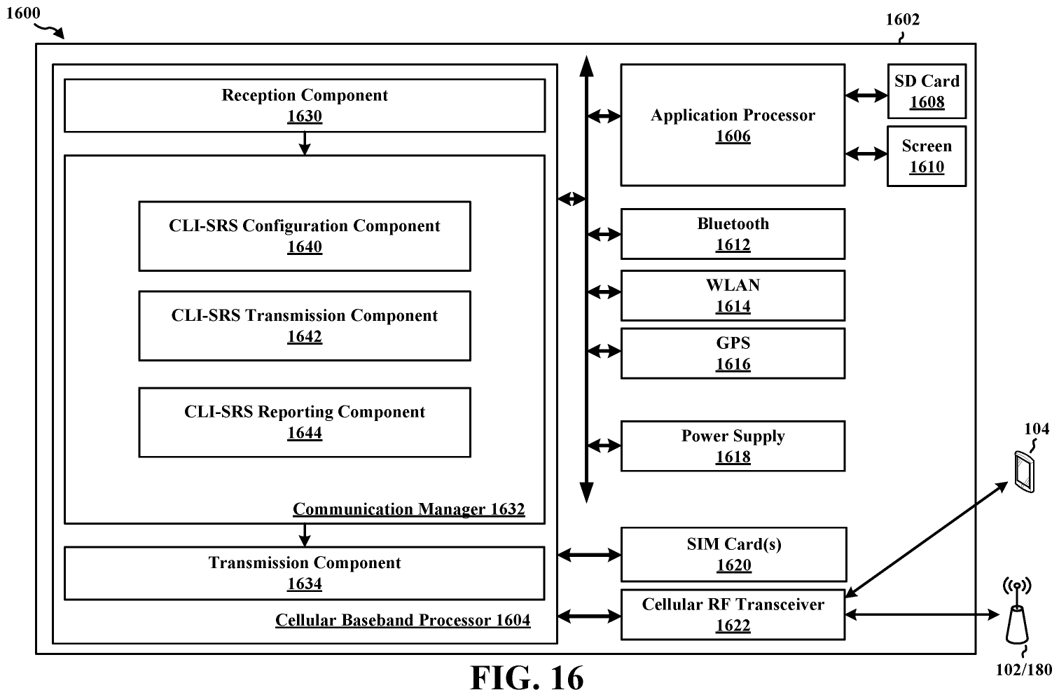

FIG. 16 is a diagram 1600 illustrating an example of a hardware implementation for an apparatus 1602. The apparatus 1602 may be a UE, a component of a UE, or may implement UE functionality. In some aspects, the apparatus 1602 may include a cellular baseband processor 1604 (also referred to as a modem) coupled to a cellular RF transceiver 1622. In some aspects, the apparatus 1602 may further include one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, or a power supply 1618. The cellular baseband processor 1604 communicates through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see 350 of FIG. 3) and include the additional modules of the apparatus 1602.

The communication manager 1632 includes a CLI-SRS configuration component 1640 that is configured to receive, from a base station, a configuration indicating a set of common resources for a SRS for CLI measurement between UEs, e.g., as described in connection with 1302, 1402, 1502 of FIGS. 13-15. The communication manager 1632 further includes a CLI-SRS transmission component 1642 that receives input in the form of a CLI-SRS configuration from the CLI-SRS configuration component 1640 and is configured to transmit a SRS in a resource in the set of common resources to other UEs in the first plurality of UEs, e.g., as described in connection with 1304 and 1508 of FIGS. 13 and 15. The communication manager 1632 further includes a CLI-SRS reporting component 1644 that receives input in the form of a CLI-SRS configuration from the CLI-SRS configuration component 1640 and is configured to measure a CLI from a SRS transmission received from another UE via a resource in the first set of common resources and to transmit, to the base station, a report of the measured CLI, e.g., as described in connection with 1404, 1406, 1504, and 1506 of FIGS. 14 and 15.

The apparatus may include additional components that perform each of the blocks of the algorithm in the flowcharts of FIGS. 13-15. As such, each block in the flowcharts of FIGS. 13-15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1602 may include a variety of components configured for various functions. In one configuration, the apparatus 1602, and in particular the cellular baseband processor 1604, includes means for receiving, from a base station, a configuration indicating a set of common resources for a SRS for cross-link interference measurement between UEs. The apparatus 1602, and in particular the cellular baseband processor 1604, may further includes means for transmitting a first SRS in a first resource in the set of common resources. The apparatus 1602, and in particular the cellular baseband processor 1604, may further includes means for measuring a cross-link interference from a SRS transmission received from a first UE via the first resource in the first set of common resources. The apparatus 1602, and in particular the cellular baseband processor 1604, may further includes means for transmitting, to the base station, a report of the measured cross-link interference. The apparatus 1602, and in particular the cellular baseband processor 1604, may further includes means for transmitting a second SRS via a second resource in the first set of common resources for measurement of the cross-link interference from the second UE. The means may be one or more of the components of the apparatus 1602 configured to perform the functions recited by the means. As described supra, the apparatus 1602 may include the TX Processor 368, the RX Processor 356, and the controller/processor 359. As such, in one configuration, the means may be the TX Processor 368, the RX Processor 356, and the controller/processor 359 configured to perform the functions recited by the means.

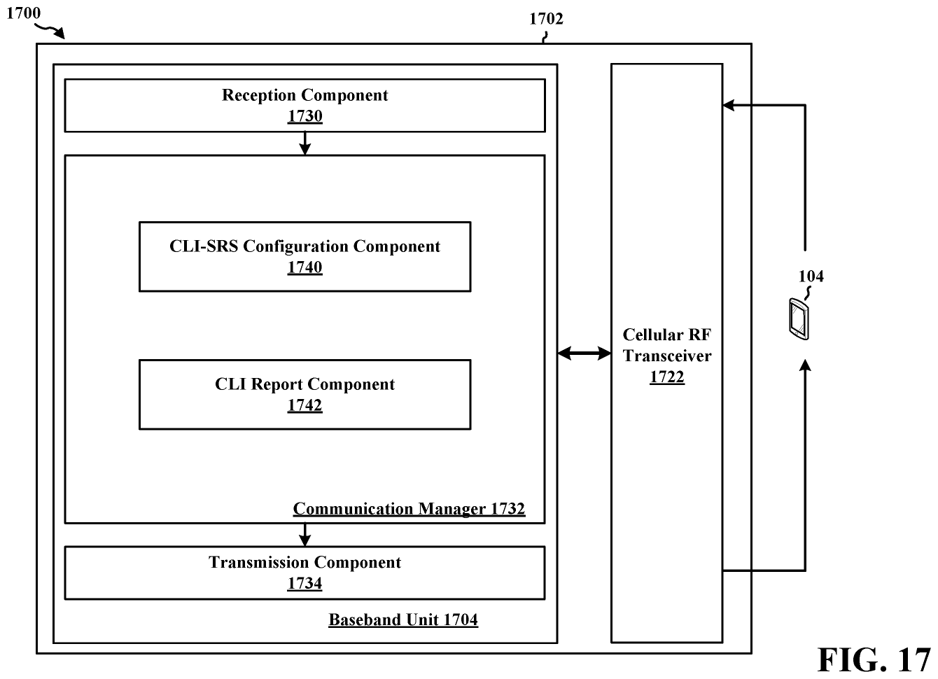

FIG. 17 is a diagram 1700 illustrating an example of a hardware implementation for an apparatus 1702. The apparatus 1702 may be a base station, a component of a base station, or may implement base station functionality. In some aspects, the apparatus 1602 may include a baseband unit 1704. The baseband unit 1704 may communicate through a cellular RF transceiver 1722 with the UE 104. The baseband unit 1704 may include a computer-readable medium/memory. The baseband unit 1704 is responsible for general processing, including the execution of software stored on the computer-readable medium/memory. The software, when executed by the baseband unit 1704, causes the baseband unit 1704 to perform the various functions described supra. The computer-readable medium/memory may also be used for storing data that is manipulated by the baseband unit 1704 when executing software. The baseband unit 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband unit 1704. The baseband unit 1704 may be a component of the base station 310 and may include the memory 376 and/or at least one of the TX processor 316, the RX processor 370, and the controller/processor 375.

The communication manager 1732 includes a CLI-SRS configuration component 1740 that may configure a first set of common resources and transmit, to at least one UE, a configuration of a first set of common resources for a SRS for CLI measurement, the first set of common resources being common to a first plurality of UEs, e.g., as described in connection with 1102, 1202, and 1206 of FIGS. 11 and 12. The communication manager 1732 further includes a CLI-SRS report component 1742 that may receive, from a second UE in the first plurality of UEs, a report of the CLI associated with a first UE in the first plurality of UEs and measured via a first resource in the first set of common resources, e.g., as described in connection with 1104, 1204, and 1208 of FIGS. 11 and 12.

The apparatus may include additional components that perform each of the blocks of the algorithm in the flowcharts of FIGS. 11 and 12. As such, each block in the flowcharts of FIGS. 11 and 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the baseband unit 1704, includes means for transmitting a configuration of a first set of common resources for a SRS) for cross-link interference measurement, the first set of common resources being common to a first plurality of UEs. The apparatus 1702, and in particular the baseband unit 1704, may further include means for receiving, from a second UE in the first plurality of UEs, a report of the cross-link interference associated with a first UE in the first plurality of UEs and measured via a first resource in the first set of common resources. The apparatus 1702, and in particular the baseband unit 1704, may further include means for transmitting a second configuration of a second set of common resources for the SRS for the cross-link interference measurement, the second set of common resources being common to a second plurality of UEs. The apparatus 1702, and in particular the baseband unit 1704, may further include means for receiving from at least one UE in the second plurality of UEs an additional report of a cross-link interference measured via the second set of common resources. The means may be one or more of the components of the apparatus 1702 configured to perform the functions recited by the means. As described supra, the apparatus 1702 may include the TX Processor 316, the RX Processor 370, and the controller/processor 375. As such, in one configuration, the means may be the TX Processor 316, the RX Processor 370, and the controller/processor 375 configured to perform the functions recited by the means.

In some aspects of wireless communication, CLI-SRS resources are configured by a base station for each of a plurality of UEs served by the base station. In order to measure CLI, CLI-SRS resources, in some aspects, are aligned for different UEs in the plurality of UEs. A base station may align a zero-power (ZP) CLI-SRS at a first UE with a non-ZP-CLI-SRS (e.g., a SRS transmission) at a second UE. Some aspects provide group-based (e.g., cell level, zone-based, or aggressor-based) CLI-SRS configurations that reduce management overhead associated with aligning CLI-SRS resources at different UEs independently. The group-based CLI-SRS resources may be used in association with communication between a UE and a base station or in association with sidelink communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to transmit a configuration of a first set of common resources for a SRS for cross-link interference measurement, the first set of common resources being common to a first plurality of UEs; and receive, from a second UE in the first plurality of UEs, a report of the cross-link interference associated with a first UE in the first plurality of UEs and measured via a first resource in the first set of common resources.

Aspect 2 is the apparatus of aspect 1, where the configuration indicates a sub-carrier spacing of the first set of common resources and a reference frequency associated with the first set of common resources.

Aspect 3 is the apparatus of aspect 2, where the configuration includes one of a set of fields in an information element associated with the SRS for the cross-link interference measurement, the set of fields including a reference sub-carrier spacing field and a reference frequency field, a first indication of the sub-carrier spacing of the first set of common resources and an indication of a frequency shift associated with the reference frequency, or a second indication of a reference BWP for derivation of the sub-carrier spacing and the reference frequency.

Aspect 4 is the apparatus of any of aspects 1 to 3, where an active BWP for communication is different than a BWP associated with the first set of common resources for the SRS for the cross-link interference measurement.

Aspect 5 is the apparatus of aspect 4, where the configuration of the first set of common resources further includes a first indication of a minimum time gap between a communication in the active BWP and a SRS transmission or a SRS measurement in the BWP associated with the first set of common resources.

Aspect 6 is the apparatus of aspect 5, where the configuration of the first set of common resources further includes a second indication for the plurality of UEs to skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement.

Aspect 7 is the apparatus of any of aspects 1 to 6, where the configuration of the first set of common resources indicates a spatial relation for the first set of common resources based on a QCL relationship to a reference signal for a cell or that is common to the first UE and the second UE.

Aspect 8 is the apparatus of any of aspects 1 to 7, where the configuration of the first set of common resources includes an indication of a set of common power control parameters associated with the first set of common resources.

Aspect 9 is the apparatus of any of aspects 1 to 8, where the first set of common resources is for a first plurality of UEs, the at least one processor coupled to the memory further configured to transmit a second configuration of a second set of common resources for the SRS for the cross-link interference measurement, the second set of common resources being common to a second plurality of UEs; and receive from at least one UE in the second plurality of UEs an additional report of a cross-link interference measured via the second set of common resources.

Aspect 10 is the apparatus of aspect 9, where the first plurality of UEs are associated with one of a first zone or a first SSB index and the second plurality of UEs are associated with one of a second zone or a second SSB index.

Aspect 11 is the apparatus of any of aspects 1 to 10, further including a transceiver coupled to the at least one processor.

Aspect 12 is an apparatus for wireless communication including at least one processor coupled to a memory and configured to receive, from a base station, a configuration indicating a set of common resources for a SRS for cross-link interference measurement between UEs; and transmitting a first SRS in a first resource in the set of common resources.

Aspect 13 is the apparatus of aspect 12, where the configuration indicates a sub-carrier spacing of the set of common resources and a reference frequency associated with the set of common resources.

Aspect 14 is the apparatus of aspect 13, where the configuration of the set of common resources includes one of a set of fields in an information element associated with the SRS for the cross-link interference measurement, the set of fields including a reference sub-carrier spacing field and a reference frequency field, a first indication of the sub-carrier spacing of the set of common resources and an indication of a frequency shift associated with the reference frequency, or a second indication of a reference BWP for derivation of the sub-carrier spacing and the reference frequency.

Aspect 15 is the apparatus of any of aspects 12 to 14, where an active BWP used for communication by the first UE is different than a BWP associated with the set of common resources for the SRS for the cross-link interference measurement.

Aspect 16 is the apparatus of aspect 15, where the configuration of the set of common resources further includes a first indication of a minimum time gap between a communication associated with the active BWP and a SRS transmission in the BWP associated with the set of common resources.

Aspect 17 is the apparatus of aspect 16, where the configuration of the set of common resources further includes a second indication for the first UE to skip one of a common-SRS operation or an UL transmission when the common-SRS operation and the UL transmission are associated with sets of resources that are separated by less than the minimum time gap, where the common-SRS operation includes one of a common-SRS transmission or a common-SRS measurement.

Aspect 18 is the apparatus of any of aspects 12 to 17, where the configuration of the first set of common resources indicates a spatial relation for the first set of common resources based on a QCL relationship to a reference signal for a cell or that is common to the first UE and the second UE.

Aspect 19 is the apparatus of any of aspects 12 to 18, where the configuration indicates a set of common power control parameters associated with the set of common resources.

Aspect 20 is the apparatus of any of aspects 12 to 19, further including a transceiver coupled to the at least one processor.

Aspect 21 is an apparatus for wireless communication including at least one processor coupled to a memory and configured to receive, from a base station, a configuration of a first set of common resources for a SRS for cross-link interference measurement between UEs; measure a cross-link interference from a SRS transmission received from a first UE via a first resource in the first set of common resources; and transmitting, to the base station, a report of the measured cross-link interference.

Aspect 22 is the apparatus of aspect 21, where the configuration indicates a sub-carrier spacing of the first set of common resources and a reference frequency associated with the first set of common resources.

Aspect 23 is the apparatus of aspect 22, where the configuration of the first set of common resources indicates one of a set of fields in an information element associated with the SRS for the cross-link interference measurement, the set of fields including a reference sub-carrier spacing field and a reference frequency field, a first indication of the sub-carrier spacing of the first set of common resources and an indication of a frequency shift associated with the reference frequency, or a second indication of a reference BWP for derivation of the sub-carrier spacing and the reference frequency.

Aspect 24 is the apparatus of any of aspects 21 to 23, where an active BWP used for communication by the second UE is different than a BWP associated with the first set of common resources for the SRS for the cross-link interference measurement.

Aspect 25 is the apparatus of aspect 24, where the configuration of the set of common resources further includes a first indication of a minimum time gap between a communication associated with the active BWP and a SRS measurement in the BWP associated with the first set of common resources; and a second indication for the second UE to skip the cross-link interference measurement in the BWP or an UL transmission when the cross-link interference measurement and the UL transmission are associated with sets of resources that are separated by less than the minimum time gap.

Aspect 26 is the apparatus of any of aspects 21 to 25, where the configuration indicates a spatial relation for the first set of common resources based on a QCL relationship to a reference signal for a cell or that is common to the first UE and the second UE.

Aspect 27 is the apparatus of any of aspects 21 to 26, where the configuration the first set of common resources includes an indication of a set of common power control parameters associated with the first set of common resources.

Aspect 28 is the apparatus of any of aspects 21 to 27, the at least one processor coupled to the memory further configured to transmit a second SRS via a second resource in the first set of common resources for measurement of the cross-link interference from the second UE.

Aspect 29 is the apparatus of any of aspects 21 to 28, further including a transceiver coupled to the at least one processor.

Aspect 30 is a method of wireless communication for implementing any of aspects 1 to 29.

Aspect 31 is an apparatus for wireless communication including means for implementing any of aspects 1 to 29.

Aspect 32 is a computer-readable medium storing computer executable code, where the code when executed by a processor causes the processor to implement any of aspects 1 to 29.

What is claimed is:

1. An apparatus for wireless communication at a base station, comprising:
a memory; and
at least one processor coupled to the memory and configured to:
transmit a configuration of a first set of common resources for a sounding reference signal (SRS) for cross-link interference measurement, the first set of common resources being common to a first plurality of UEs; and
receive, from a second UE in the first plurality of UEs, a report of a cross-link interference associated with a first UE in the first plurality of UEs and measured via a first resource in the first set of common resources.

2. The apparatus of claim 1, wherein the configuration indicates a sub-carrier spacing of the first set of common resources and a reference frequency associated with the first set of common resources.

3. The apparatus of claim 2, wherein the configuration includes one of:
a set of fields in an information element associated with the SRS for the cross-link interference measurement, the set of fields comprising a reference sub-carrier spacing field and a reference frequency field,
a first indication of the sub-carrier spacing of the first set of common resources and of a frequency shift associated with the reference frequency, or
a second indication of a reference bandwidth part (BWP) for derivation of the sub-carrier spacing and the reference frequency.

4. The apparatus of claim 1, wherein an active bandwidth part (BWP) for communication is different than a BWP associated with the first set of common resources for the SRS for the cross-link interference measurement.

5. The apparatus of claim 4, wherein the configuration of the first set of common resources further comprises:
a first indication of a minimum time gap between the communication in the active BWP and a SRS transmission or a SRS measurement in the BWP associated with the first set of common resources.

6. The apparatus of claim 5, wherein the configuration of the first set of common resources further comprises:
a second indication for the plurality of UEs to skip one of a common-SRS operation or an UL transmission when the common-SRS operation and the UL transmission are associated with sets of resources that are separated by less than the minimum time gap, wherein the common-SRS operation comprises one of a common-SRS transmission or a common-SRS measurement.

7. The apparatus of claim 1, wherein the configuration of the first set of common resources indicates a spatial relation for the first set of common resources based on a quasi co-location (QCL) relationship to a reference signal for a cell or that is common to the first UE and the second UE.

8. The apparatus of claim 1, wherein the configuration of the first set of common resources includes an indication of a set of common power control parameters associated with the first set of common resources.

9. The apparatus of claim 1, the at least one processor coupled to the memory further configured to:
transmit a second configuration of a second set of common resources for the SRS for the cross-link interference measurement, the second set of common resources being common to a second plurality of UEs; and
receive from at least one UE in the second plurality of UEs an additional report of an additional cross-link interference measured via the second set of common resources.

10. The apparatus of claim 9, wherein the first plurality of UEs are associated with one of a first zone or a first synchronization signal block (SSB) index and the second plurality of UEs are associated with one of a second zone or a second SSB index.

11. The apparatus of claim 1, further comprising a transceiver coupled to the at least one processor.

12. An apparatus for wireless communication at a first user equipment (UE), comprising:
a memory; and
at least one processor coupled to the memory and configured to:
receive, from a base station, a configuration indicating a set of common resources for a sounding reference signals (SRS) for cross-link interference measurement between UEs; and
transmitting a first SRS in a first resource in the set of common resources.

13. The apparatus of claim 12, wherein the configuration indicates a sub-carrier spacing of the set of common resources and a reference frequency associated with the set of common resources.

14. The apparatus of claim 13, wherein the configuration of the set of common resources includes one of:
a set of fields in an information element associated with the SRS for the cross-link interference measurement, the set of fields comprising a reference sub-carrier spacing field and a reference frequency field,
a first indication of the sub-carrier spacing of the set of common resources and of a frequency shift associated with the reference frequency, or
a second indication of a reference bandwidth part (BWP) for derivation of the sub-carrier spacing and the reference frequency.

15. The apparatus of claim 12, wherein an active bandwidth part (BWP) used for communication by the first UE is different than a BWP associated with the set of common resources for the SRS for the cross-link interference measurement.

16. The apparatus of claim 15, wherein the configuration of the set of common resources further comprises:
a first indication of a minimum time gap between a communication associated with the active BWP and a SRS transmission in the BWP associated with the set of common resources.

17. The apparatus of claim 16, wherein the configuration of the set of common resources further comprises:
a second indication for the first UE to skip one of a common-SRS operation or an UL transmission when the common-SRS operation and the UL transmission are associated with sets of resources that are separated by less than the minimum time gap, wherein the common-SRS operation comprises one of a common-SRS transmission or a common-SRS measurement.

18. The apparatus of claim 12, wherein the configuration indicates a spatial relation for the set of common resources based on a quasi co-location (QCL) relationship to a reference signal for a cell or that is common to the first UE and a second UE.

19. The apparatus of claim 12, wherein the configuration indicates a set of common power control parameters associated with the set of common resources.

20. The apparatus of claim 12, further comprising a transceiver coupled to the at least one processor.

21. An apparatus for wireless communication at a second user equipment (UE), comprising:
a memory; and
at least one processor coupled to the memory and configured to:
receive, from a base station, a configuration of a first set of common resources for a sounding reference signal (SRS) for cross-link interference measurement between UEs;
measure a cross-link interference from a SRS transmission received from a first UE via a first resource in the first set of common resources; and
transmitting, to the base station, a report of the measured cross-link interference.

22. The apparatus of claim 21, wherein the configuration indicates a sub-carrier spacing of the first set of common resources and a reference frequency associated with the first set of common resources.

23. The apparatus of claim 22, wherein the configuration of the first set of common resources indicates one of:
a set of fields in an information element associated with the SRS for the cross-link interference measurement, the set of fields comprising a reference sub-carrier spacing field and a reference frequency field,
a first indication of the sub-carrier spacing of the first set of common resources and of a frequency shift associated with the reference frequency, or
a second indication of a reference bandwidth part (BWP) for derivation of the sub-carrier spacing and the reference frequency.

24. The apparatus of claim 21, wherein an active bandwidth part (BWP) used for communication by the second UE is different than a BWP associated with the first set of common resources for the SRS for the cross-link interference measurement.

25. The apparatus of claim 24, wherein the configuration of the set of common resources further comprises:
a first indication of a minimum time gap between a communication associated with the active BWP and a SRS measurement in the BWP associated with the first set of common resources; and
a second indication for the second UE to skip the cross-link interference measurement in the BWP or an UL transmission when the cross-link interference measurement and the UL transmission are associated with sets of resources that are separated by less than the minimum time gap.

26. The apparatus of claim 21, wherein the configuration indicates a spatial relation for the first set of common resources based on a quasi co-location (QCL) relationship to a reference signal for a cell or that is common to the first UE and the second UE.

27. The apparatus of claim 21, wherein the configuration the first set of common resources includes an indication of a set of common power control parameters associated with the first set of common resources.

28. The apparatus of claim 21, the at least one processor coupled to the memory further configured to:
transmit a second SRS via a second resource in the first set of common resources for measurement of the cross-link interference from the second UE.

29. The apparatus of claim 21, further comprising a transceiver coupled to the at least one processor.

30. A method for wireless communication at a base station comprising:
transmitting a configuration of a first set of common resources for a sounding reference signal (SRS) for cross-link interference measurement, the first set of common resources being common to a first plurality of UEs; and
receiving, from a second UE in the first plurality of UEs, a report of a cross-link interference associated with a first UE in the first plurality of UEs and measured via a first resource in the first set of common resources.
